(19) United States
(12) Patent Application Publication
(10) Pub. No.: US 2024/0265036 A1
(43) Pub. Date: Aug. 8, 2024

(54) INTELLIGENT GRAPH FOR REPRESENTING DATA OBJECTS

(71) Applicant: OneTrust, LLC, Atlanta, GA (US)

(72) Inventors: Subramanian Viswanathan, San Ramon, CA (US); Milap Shah, Bangalore (IN)

(21) Appl. No.: 18/691,416

(22) PCT Filed: Sep. 23, 2022
(86) PCT No.: PCT/US22/44574

§ 371 Date: Mar. 12, 2024

Related U.S. Application Data
(60) Provisional application No. 63/247,608, filed on Sep. 23, 2021.

(51) Int. Cl. G06F 16/28

(52) U.S. Cl. CPC G06F 16/287

(57) ABSTRACT

The present disclosure provides methods, apparatus, systems, computing devices, computing entities, and/or the like for providing persistent representations in graph data structures of relationships that exist among data objects found across different data-related processes to enable efficient querying of data from the different data-related processes.

### CROSS-REFERENCE TO RELATED APPLICATIONS

This application claims the benefit of U.S. Provisional Patent Application Ser. No. 63/247,608, filed Sep. 23, 2021, which is hereby incorporated herein by reference in its entirety.

### TECHNICAL FIELD

The present disclosure is generally related to systems and methods for organizing and inter-relating data objects that can be defined within various data-related processes to allow for aggregate analysis of the data objects.

### BACKGROUND

Data objects used within data-related processes can often have relationships among themselves although the data-related processes may be independent from one another. For example, different data objects defined within data used by various microservices may have relationships among the different data objects although the various microservices are self-contained and autonomous. Therefore, conducting any type of aggregate analysis on the data used within the various microservices can be difficult since the relationships among the data objects are not readily available to draw upon in conducting the analysis. Accordingly, a need exists in the relevant technology for maintaining a representation of such relationships. Furthermore, a need exists in the relevant technology for maintaining a representation of such relationships while also maintaining autonomy among the various data-related processes.

### SUMMARY

In general, various aspects of the disclosure provide methods, apparatus, systems, computing devices, computing entities, and/or the like for providing representations of relationships that exist among data objects found over various data-related processes. In accordance with one aspect, a method is provided that comprises: providing a graphical user interface configured to allow for defining (i) a custom data object type used within a first data-related process of a plurality of data-related processes and (ii) a first plurality of attributes for the custom data object type, wherein the custom data object type is not found in a plurality of base data object types being used within the plurality of data-related processes; receiving, by computing hardware, the custom data object type, the first plurality of attributes, and a relationship type that can exist between the custom data object type and a base data object type of the plurality of base data object types, wherein the base data object type is used within a second data-related process of the plurality of data-related processes; generating, by the computing hardware, a first data object type node and an edge in a graph data representation, wherein the first data object type node represents the custom data object type and is associated with the first plurality of attributes and the edge represents the relationship type that can exist between the custom data object type and the base data object type and connects the first data object type node with a second data object type node representing the base data object type; and generating, by the computing hardware, a visual representation for display on the graphical user interface, wherein the visual representation comprises at least a portion of the graph data representation showing the first data object type node, the second data object type node, and the edge. In some aspects, each of the plurality of data-related processes comprises a microservice. In some aspects, the plurality of data-related processes supports an enterprise software application.

In some aspects, the method further comprises: receiving data, originating from the graphical user interface, wherein the data comprises: a selection of the custom data object type, a first property defined for a first attribute of the first plurality of attributes, a selection of the base data object type, a second property defined for a second attribute of a second plurality of attributes for the base data object type, and a selection of the relationship type; generating, by the computing hardware, a first instance node, a second instance node, and an instance edge in a second graph data representation, wherein the first instance node represents an instance of the custom data object type and is associated with the first property, the second instance node represents an instance of the base data object type and is associated with the second property, and the instance edge represents the relationship type existing between the instance of the custom data object type and the instance of the base data object type; and generating, by the computing hardware, a second visual representation for display on the graphical user interface, wherein the second visual representation comprises at least a portion of the second graph data representation showing the first instance node, the second instance node, and the instance edge.

In some aspects, the method further comprises: providing, by the computing hardware, a third visual representation for display on the graphical user interface, wherein the third visual representation comprises at least a portion of the graph data representation showing the first data object type node as selectable, the second data object type node as selectable, and the edge as selectable; receiving, by the computing hardware, data originating from the graphical user interface, wherein the data comprises: a selection of the first data object type node, the first property defined for the first attribute, a selection of the second data object type node, a selection of the second attribute, and a selection of the edge; responsive to receiving the data, conducting, by the computing hardware, a traversal of the second graph data representation to retrieve the second property, wherein the traversal of the second graph data representation comprises: identifying the first instance node in the second graph data representation based on the first property, traversing the instance edge in the second graph data representation based on the edge to identify the second instance node, and identifying the second property; and providing, by the computing hardware, the second property for display in the graphical user interface.

In some aspects, the method further comprises populating, by the computing hardware, at least one placeholder field in a data schema for the first data-related process with data identifying the custom data object type and the first plurality of attributes. In some aspects, the method further comprises: providing a second graphical user interface configured to allow for defining (i) a custom relationship type and (ii) a third plurality of attributes for the custom relationship type; receiving, by the computing hardware, the custom relationship type, the third plurality of attributes, and an indication that the custom relationship type can exist between the custom data object type and the base data object type; generating, by the computing hardware, a second edge in the graph data representation, wherein the second edge represents the custom relationship type that can exist between the custom data object type and the base data object type, connects the first data object type node with the second data object type node, and is associated with the third plurality of attributes; and providing, by the computing hardware, the second edge for display in the visual representation.

In accordance with another aspect, a method is provided that comprises: providing, by computing hardware, a first data object type, a second data object type, and a relationship type in a graphical user interface for selection, wherein: the first data object type (i) can be used within a plurality of data-related processes and (ii) is represented by a first data object type node (a) found in a first graph data representation of a graph data structure and (b) is associated with a first plurality of attributes defined for the first data object type, the second data object type (i) can be used within the plurality of data-related processes and (ii) is represented by a second data object type node (a) found in the first graph data representation of the graph data structure and (b) is associated with a second plurality of attributes defined for the second data object type, and the relationship type (i) can exist between the first data object type and the second data object type and (ii) is represented by an edge found in the first graph data representation of the graph data structure; receiving data, originating from the graphical user interface, wherein the data comprises: a selection of the first data object type to represent an instance of the first data object type used within a first data-related process of the plurality of data-related processes, a first property for a first attribute of the first plurality of attributes, a selection of the second data object type to represent an instance of the second data object type used within a second data-related process of the plurality of data-related processes, a second property for a second attribute of the second plurality of attributes, and a selection of the relationship type representing an instance of the relationship type existing between the instance of the first data object type and the instance of the second data object type; generating, by the computing hardware, a first instance node, a second instance node, and an instance edge in a second graph data representation of the graph data structure, wherein the first instance node represents the instance of the first data object type and is associated with the first property, the second instance node represents the instance of the second data object type and is associated with the second property, and the instance edge represents the relationship type existing between the instance of the first data object type and the instance of the second data object type; and generating, by the computing hardware, a visual representation for display on the graphical user interface, wherein the visual representation comprises at least a portion of the second graph data representation showing the first instance node, the second instance node, and the instance edge. In some aspects, each of the plurality of data-related processes comprises a microservice. In some aspects, the plurality of data-related processes supports an enterprise software application.

In some aspects, the method further comprises: providing a second graphical user interface configured to allow for defining (i) the first data object type and (ii) the first plurality of attributes; receiving, by the computing hardware, the first data object type, the first plurality of attributes; and generating, by the computing hardware, the first data object type node and the edge in the first graph data representation. In some aspects, the method further comprises populating, by the computing hardware, at least one placeholder field in a data schema for the first data-related process with data identifying the first data object type and the first plurality of attributes.

In some aspects, the method further comprises: providing, by the computing hardware, a second visual representation for display on the graphical user interface, wherein the second visual representation comprises at least a portion of the first graph data representation showing the first data object type node as selectable, the second data object type node as selectable, and the edge as selectable; receiving, by the computing hardware, data originating from the graphical user interface, wherein the data comprises: a selection of the first data object type node, the first property defined for the first attribute, a selection of the second data object type node, the second attribute, and a selection of the edge; responsive to receiving the data, conducting, by the computing hardware, a traversal of the second graph data representation to retrieve the second property, wherein the traversal of the second graph data representation comprises: identifying the first instance node in the second graph data representation based on the first property, traversing the instance edge in the second graph data representation based on the edge to identify the second instance node, and identifying the second property; and providing, by the computing hardware, the second property for display on the graphical user interface.

In some aspects, the method further comprises: providing a second graphical user interface configured to allow for defining (i) a custom relationship type and (ii) a third plurality of attributes for the custom relationship type; receiving, by the computing hardware, the custom relationship type, the third plurality of attributes, and an indication that the custom relationship type can exist between the first data object type and the second data object type; generating, by the computing hardware, a second edge in the first graph data representation, wherein the second edge represents the custom relationship type that can exist between the first data object type and the second data object type, connects the first data object type node with the second data object type node, and is associated with the third plurality of attributes; and providing, by the computing hardware, the second edge for display in the visual representation.

In accordance with another aspect, a method is provided that comprises: receiving, by computing hardware, data, wherein the data identifies: a first data object type used within a first data-related process, a first plurality of attributes defined for the first data object type, a second data object type used within a second data-related process, a second plurality of attributes defined for the second data object type, and a relationship type that can exist between the first data object type and the second data object type; populating, by the computing hardware, at least one first placeholder field in a first data schema for the first data-related process with the data identifying the first data object type and the first plurality of attributes; populating, by the computing hardware, at least one second placeholder field in a second data schema for the second data-related process with the data identifying the second data object type and the second plurality of attributes; generating, by the computing hardware, a first data object type node, a second data object type node, and an edge in a graph data representation, wherein the first data object type node represents the first data object type and is associated with the first plurality of attributes, the second data object type node represents the second data object type and is associated with the second plurality of attributes, and the edge represents the relationship type that can exist between the first data object type and the second data object type; and generating, by the computing hardware, a visual representation for display on a graphical user interface, wherein the visual representation comprises at least a portion of the graph data representation showing the first data object type node, the second data object type node, and the edge. In some aspects, each of the first data-related process and the second data-related process comprises a microservice. In some aspects, the first data-related process and the second data-related process supports an enterprise software application.

In some aspects, the method further comprises: receiving data, originating from the graphical user interface, wherein the data comprises: a selection of the first data object type, a first property defined for a first attribute of the first plurality of attributes, a selection of the second data object type, a second property defined for a second attribute of the second plurality of attributes, and a selection of the relationship type; generating, by the computing hardware, a first instance node, a second instance node, and an instance edge in a second graph data representation, wherein the first instance node represents an instance of the first data object type and is associated with the first property, the second instance node represents an instance of the second data object type and is associated with the second property, and the instance edge represents the relationship type existing between the instance of the first data object type and the instance of the second data object type; and generating, by the computing hardware, a second visual representation for display on the graphical user interface, wherein the second visual representation comprises at least a portion of the second graph data representation showing the first instance node, the second instance node, and the instance edge.

In some aspects, the method further comprises: providing, by the computing hardware, a third visual representation for display on the graphical user interface, wherein the third visual representation comprises at least a portion of the graph data representation showing the first data object type node as selectable, the second data object type node as selectable, and the edge as selectable; receiving, by the computing hardware, second data originating from the graphical user interface, wherein the second data comprises: a selection of the first data object type node, the first property defined for the first attribute, a selection of the second data object type node, the second attribute, and a selection of the edge; responsive to receiving the second data, conducting, by the computing hardware, a traversal of the second graph data representation to retrieve the second property, wherein the traversal of the second graph data representation comprises: identifying the first instance node in the second graph data representation based on the first property, traversing the instance edge in the second graph data representation based on the edge to identify the second instance node, and identifying the second property; and providing, by the computing hardware, the second property for display on the graphical user interface.

In some aspects, the method further comprises populating, by the computing hardware, at least one placeholder field in a data schema for the first data-related process with second data identifying the first data object type and the first plurality of attributes. In some aspects, the method further comprises: providing a second graphical user interface configured to allow for defining (i) a custom relationship type and (ii) a third plurality of attributes for the custom relationship type; receiving, by the computing hardware, the custom relationship type, the third plurality of attributes, and an indication that the custom relationship type can exist between the first data object type and the second data object type; generating, by the computing hardware, a second edge in the graph data representation, wherein the second edge represents the custom relationship type that can exist between the first data object type and the second data object type, connects the first data object type node with the second data object type node, and is associated with the third plurality of attributes; and providing, by the computing hardware, the second edge for display in the visual representation.

In accordance with another aspect, a method is provided that comprises: providing, by computing hardware, a graphical user interface for display on a computing device, wherein the graphical user interface displays a visual representation of at least a portion of a schema graph representation as: a plurality of data object type nodes representing a plurality of data object types that can be used within a plurality of data-related processes in which each data object type node of the plurality of data object type nodes (i) is selectable and (ii) is associated with a plurality of corresponding attributes, a plurality of relationship type edges representing relationship types that can exist between the plurality of data object types in which each relationship type edge of the plurality of relationship type edges (i) is selectable and (ii) connects two data object type nodes of the plurality of data object type nodes, receiving, by the computing hardware, data originating from the graphical user interface, wherein the data comprises: a selection of a first data object type node from the plurality of data object type nodes, a first property defined for a first attribute of the plurality of corresponding attributes associated with the first data object type node, a selection of a second data object type node from the plurality of data object type nodes, a selection of a relationship type edge of the plurality of relationship type edges displayed on the graphical user interface connecting the first data object type node and the second data object type node, and a selection of a second attribute of the plurality of corresponding attributes associated with the second data object type node; responsive to receiving the data, conducting, by the computing hardware, a traversal of an operations graph representation to retrieve a second property for the second attribute, wherein the traversal of the operations graph representation comprises: identifying a first data object instance node in the operations graph representation based on the first property, the first data object instance node representing a first instance of a use of a first data object type represented by the first data object type node in a first data-related process of the plurality of data-related processes, traversing an instance edge in the operations graph representation based on the relationship type edge connecting the first data object type node and the second data object type node to identify a second data object instance node, the second data object instance node representing a second instance of a use of a second data object type represented by the second data object type node in a second data-related process of the plurality of data-related processes, and identifying the second property associated with the second data object instance node; and providing, by the computing hardware, the second property for display on the graphical user interface.

In some aspects, the portion of the schema graph representation is based on a particular workflow. In some aspects, the graphical user interface further displays a plurality of workflows, and the method further comprises receiving a selection of the particular workflow. In some aspects, at least one of the plurality of data object types or the plurality of relationship type edges is based on the particular workflow.

In some aspect, the method further comprises: querying, by the computing hardware, a repository of the second data-related process to retrieve an additional property associated with the second instance of the use of the second data object type represented by the second data object type node; and providing, by the computing hardware, the second property for display on the graphical user interface.

In accordance with other aspects, a system is provided that comprises a non-transitory computer-readable medium storing instructions and a processing device communicatively coupled to the non-transitory computer-readable medium. Accordingly, the processing device is configured to execute the instructions and thereby perform operations similar to the steps of the methods. In addition, in accordance with other aspects, a non-transitory computer-readable medium is provided having instructions that are stored thereon. Accordingly, the instructions are executable by one or more processing devices for performing operations similar to the methods.

### BRIEF DESCRIPTION OF THE DRAWINGS

In the course of this description, reference will be made to the accompanying drawings, which are not necessarily drawn to scale, and wherein:

FIG. 1 depicts an example of a computing environment that may be used in accordance with various aspects of the present disclosure;

FIG. 2 depicts an example of a centralized platform that may be used in accordance with various aspects of the present disclosure;

FIG. 3 is an example of a process for creating custom data object types in accordance with various aspects of the present disclosure;

FIG. 4 is an example of a process for identifying a relationship type that may exist between data object types in accordance with various aspects of the present disclosure;

FIG. 5 is an example of a process for providing data object types for a data-related process in accordance with various aspects of the present disclosure;

FIG. 6 provides an example of a custom data object type and corresponding custom relationship types;

FIG. 7 is an example of a process for generating an instance of a data object type in accordance with various aspects of the present disclosure;

FIG. 8 is an example of a process for generating instances of relationship types in accordance with various aspects of the present disclosure;

FIG. 9 provides examples of a schema graph representation and an operations graph representation that may be used in accordance with various aspects of the present disclosure;

FIG. 10 is an example of a process for generating a query in accordance with various aspects of the present disclosure;

FIG. 11 provides an example of a workflow model that may be used in accordance with various aspects of the present disclosure;

FIG. 12 provides another example of a workflow model that may be used in accordance with various aspects of the present disclosure;

FIG. 13 is a block diagram illustrating an example of a system architecture that may be used in accordance with various aspects of the present disclosure; and

FIG. 14 is a schematic diagram of an example of a computing entity that may be used in accordance with various aspects of the present disclosure.

### DETAILED DESCRIPTION

Various aspects for practicing the technologies disclosed herein are described more fully hereinafter with reference to the accompanying drawings, in which some, but not all aspects of the technologies disclosed are shown. Indeed, the aspects disclosed herein are provided so that this disclosure will satisfy applicable legal requirements and should not be construed as limiting or precluding other aspects applying the teachings and concepts disclosed herein. Like numbers in the drawings refer to like elements throughout.

### Overview

Many enterprise software applications, services, and/or the like are provided in a software as a service (SaaS) framework. SaaS has become a common delivery model for such applications and services in which SaaS is typically supported by a cloud-based environment and accessed by users using a thin client such as a Web browser. Microservice-based architectures are often preferable in cloud-based environments involving large, complex applications, services, and/or the like that require flexible development, deployment, and scaling. A microservices application, for example, may be implemented using multiple, separate, and self-contained applications, or microservices, that each provide a particular service and collectively form one or more fully functional applications within a SaaS framework.

A microservices architecture may allow each underlying microservice to be independently developed, deployed, updated, and scaled, resulting in numerous efficiencies in the software development process. As a result, a microservice can be developed using the most appropriate programming language and/or technology for the particular microservice. A microservice can also be deployed on the hardware that is best suited for its respective requirements and functionality. For example, a microservice can be implemented using a virtual machine and/or software container. A software container can be an effective complement to a microservice because a container can be used to ensure that a microservice runs the same in any environment or infrastructure.

In addition, the independent, distributed nature of microservice-based architectures can enable microservices to be independently deployed and updated. Microservice-based architectures can also facilitate rolling updates, where only some instances of a particular microservice are updated at any given time, allowing updates to be “rolled back,” if needed, or undone before all instances of the microservice are updated. Furthermore, microservice-based architectures can enable each microservice to be scaled independently, resulting in more efficient load balancing. For instance, a particular microservice can be scaled by deploying any number of instances of the microservice as needed to satisfy the capacity and availability constraints of that microservice. For example, if a spike in incoming traffic for a particular microservice occurs, the microservice can be scaled accordingly without having to scale other microservices.

A microservice can generally be understood to provide one or more particular functions that may be combined with one or more functions provided by other microservices. For example, a microservice may include a data repository, as well as an application programming interface (API). Here, the microservice may be designed to execute its own process and/or logic, using data from the data repository and/or inputs received by way of the API, while providing outputs by way of the API. Meanwhile, other microservices execute in a similar fashion. That is to say, one or more additional microservices may be executed in conjunction with the microservice to provide aggregated outputs, as well as perform other functionality, objectives, and/or the like. Thus, each microservice effectively encapsulates its individual data with corresponding processes and logic operating thereon, and an architectural principle behind the use of microservices is this autonomy.

Unfortunately, many of the features and advantages of the microservices just described may be restrictive with respect to performing operations across the various microservices. For instance, the maintenance and use of an independent data repository for each microservice with its own schema can restrict and/or eliminate an ability to provide aggregated analysis of the data used for the various microservices. For example, several domain data objects may exist within the data used for individual microservices across an ecosystem that have relationships to each other, both directly and indirectly. Accordingly, these domain data objects may be defined within the schemas for the corresponding data repositories. However, the relationships that exist between the domain data objects of the various microservices cannot be defined within the schemas of the microservices in order to maintain autonomy. Therefore, conducting an aggregated analysis involving the various domain data objects found across the microservices can be challenging, if not impossible.

Accordingly, various aspects of the disclosure overcome many of the technical challenges of representing these relationships that exist between the domain data objects of various microservices while still maintaining the autonomy of the microservices. Specifically, various aspects of the disclosure provide a centralized platform that facilitates the capturing of these relationships in a persistent manner as opposed to representing these relationships within the individual microservices. In particular aspects, the platform involves the use of a graph data structure for defining and persisting the relationships of different domain data objects found in data used across the various microservices. In certain aspects, the graph data structure can include one or more graph data representations that are used in depicting the different domain data objects and mapping relationships between the different domain data objects. In some aspects, the platform involves using a first graph data representation (e.g., a schema graph representation) in depicting various data object types that may exist within different microservices, as well as relationship types that may exist between the different data object types. For example, a first data object type may represent a first type of entity, element, activity, process, and/or the like that may exist within one or more microservices, while a second data object type may represent a second type of entity, element, activity, process, and/or the like that may exist within the one or more microservices. Accordingly, a relationship type may represent a form of relationship that may exist between the first data object type and the second data object type.

In some aspects, the platform involves the use of a second graph data representation (e.g., an operations graph representation) in depicting instances of the various data object types that exist within the different microservices, as well as instances of the relationship types that exist between the instances of the data object types. For example, a first instance of a data object type may represent a particular processing activity defined within a first microservice, while a second instance of the data object type may represent a particular processing activity defined within a second, separate microservice. Here, the two processing activities may be indirectly related in that both processing activities may use a common data element that is provided by an independent third-party data source. In this example, the platform can facilitate defining an instance of a relationship type within the second graph data representation to represent this indirect relationship.

Further, the platform can facilitate defining one or more attributes for the different data object types and different relationship types. Accordingly, the platform can facilitate providing one or more properties for the attribute(s) in defining a particular instance of a data object or relation type. These attributes and/or properties can then be used in developing custom queries for the graph data representations to allow for users to answer questions on the relationships that exist between the domain data objects of the different microservices. Thus, in various aspects, the platform can facilitate the capture of relationships among the domain data objects of the different microservices while still maintaining the autonomy of the microservices.

In addition to addressing the technical challenges of representing the relationships among data objects across various microservices while still maintaining the autonomy of the microservices, the platform allowing the mapping of the instances of data object types, instances of relationship types, and properties for corresponding attributes into a graph data structure can lead to a data representation that is more computationally efficient than found in many other conventional data representations. For example, the platform's use of the graph data structure allows for relationships that exist between data objects of different microservices to exist within the graph data structure in a persistent manner so that they can be queried (e.g., traversed) very quickly. Other conventional data structures such as relational databases do not provide for persistent existence of relationships between data items.

In addition, the platform's use of the different graph data representations according to various aspects allows for visual representations of the various data object types, relationship types, and instances thereof to be displayed on a graphical user interface in such a manner to allow users to construct (generate) custom queries by navigating through data object types and relationship types of interest and defining properties for the various attributes as query parameters. In various aspects, the graphical user interface can allow for users to define custom object types and/or relationship types for one or more microservices. In some aspects, the platform can make use of placeholders (e.g., placeholder fields) within the data schemas for the different microservices to maintain the autonomy of the microservices.

Further, in various aspects, the platform's use of the graph data structure allows for a large volume of data representing the various data objects found over the different microservices to be represented and managed in an efficient manner. The graph data structure can facilitate a consistent performance in the computational processing of queries performed for the various data objects across the different microservices as relationships grow between the different data objects. Therefore, the platform can allow for the processing of queries on the various data objects across the different microservices that may not otherwise be achievable using conventional data representations. For example, queries conducted for relational databases are known to be slow as relationships between data items stored within the databases grow. The platform according to various aspects overcomes this technical disadvantage. In addition, the platform's use of the graph data structure can allow for the graph data structure and schema to grow as more data object types, relationship types, and instances thereof are introduced, providing for a flexible solution. Thus, the platform in various aspects provides a novel approach that can enable computing systems to perform custom querying tasks on data objects existing over a number of different microservices in a computationally efficient manner that increases performance of these computing systems, as well as increases the capacity and efficiency of these computing systems.

It is noted that microservices are discussed throughout the disclosure, however various aspects of the platform be used for other forms of data-related processes such as, for example, service-oriented architectures, miniservices architectures, and/or the like. Therefore, continued discussion of microservices in conjunction with various aspects of the disclosure should not be viewed as limiting the scope of the disclosure and should be understood that other forms of data-related processes are contemplated for use along with various aspects of the platform.

In addition, a “service” provide through an enterprise software application as discussed herein is associated with a single microservice for simplicity. However, a “service” can be associated with multiple microservices in some instances. Therefore, aspects of the platform are contemplated in which a user may select a particular service, as opposed to a particular microservice as discussed herein, in performing certain functionality provided through the platform. In these instances, functionality provided through the platform may be performed on multiple microservices associated with a particular service. Further detail on various aspects of the platform is now provided.

### Example of Real-World Scenario

An example of a real-world scenario is provided and used herein to assist the reader's understanding of various aspects of the disclosure. The example should not be construed as limiting the scope of the disclosure. In the example, an organization furnishes an enterprise software application via a SaaS architecture that provides a variety of data privacy-related services such as, for example, vendor risk management, data mapping, data subject access request management, management of policy governance and compliance, and/or the like. Here, the enterprise software application involves an architecture that provides each of the services as one or more microservices that can be accessed by users (e.g., other organizations that are “clients” of the enterprise software application) using various APIs, thin clients, and/or the like. For example, the management of policy governance and compliance service enables a user (e.g., personnel thereof) of the enterprise software application to manage data (information) regarding its use of personal data within the user to ensure that the user is operating in compliance with applicable privacy policies. Therefore, the microservices can allow for providing the services as operations within the enterprise software architecture independent of each other.

However, many of the users often subscribe to multiple services provided through the enterprise software application. For example, a user may subscribe to both: (1) a vendor risk management service that enables the user to make use of various vendors while remaining in compliance with applicable privacy policies, and also (2) the management of policy governance and compliance service. In addition, the data (information) used within these two services may have data objects that are related to one another.

In a particular example, the user may produce custom t-shirts. Here, the user may use a third-party vendor (an e-commerce retailer) to sell the custom t-shirts through a website run by the third-party vendor. Upon making a sale, the third-party vendor provides information such as a shipping address of the purchaser so that the user can then produce the ordered custom t-shirts and ship them to the purchaser accordingly. The shipping address of the purchaser may be viewed as personal data that is subject to one or more privacy policies. Therefore, the user may use the management of policy governance and compliance service and the vendor risk management service to ensure that the users remains in compliance with the one or more privacy policies, where the shipping address is a common data object that is used in each of the two services.

The user may be interested in analyzing its internal processes used in producing the custom t-shirts that make use of the shipping address, as well as the internal processes of the third-party vendor that make use of the shipping address. In particular, the user may be interested in conducting such an analysis to evaluate the level of risk that the user is incurring due to the handling of the shipping address both internally and by the third-party vendor. Accordingly, the management of policy governance and compliance service may contain data (information) on the internal processes of the user and the vendor risk management service may contain data on the internal processes of the third-party vendor. That is to say, a domain repository of a microservice providing the management of policy governance and compliance service may contain the data on the internal processes of the user and a domain repository of a microservice providing the vendor risk management service may contain the data on the internal processes of the third-party vendor. Because the two repositories are maintained independently of each other, querying the internal processes for both the user and the third-party vendor (and any relationships that may be exist between them) can be a difficult challenge.

Accordingly, various aspects of the disclosure overcome such a challenge by providing a centralized platform to capture and persist relationships between data objects that may be found across different, independent data-related processes such as microservices found within an enterprise software architecture. As a result, various aspects of the disclosure can allow for the user in the example to generate a query that is able to return the desired data (information) on the internal processes from both services so that the risk analysis can be carried out in an effective and efficient manner. Additional detail is now provided on various aspects of the platform, as well as aspects of various modules that may be provided and used within the platform.

### Example Computing Environment

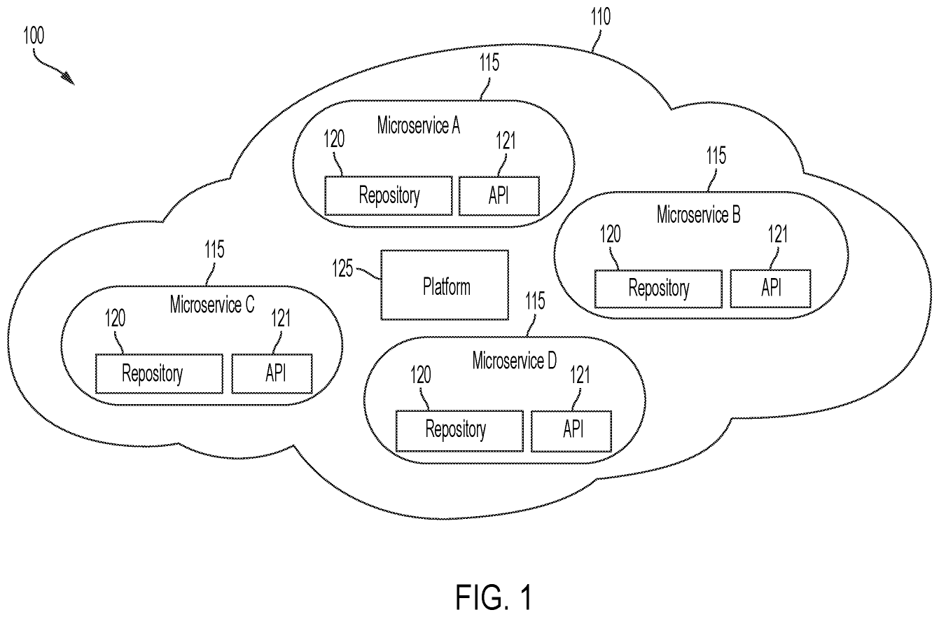

FIG. 1 depicts an example computing environment of a microservice-based enterprise software application 100 in which a centralized platform 125 is provided according to various aspects to capture and persist relationships between data objects across an ecosystem of various data-related processes. In the depicted example, a cloud environment 110 hosts the enterprise software application 100 that is composed of a plurality of microservices 115 representing the data-related processes that are utilized by various services provided through the enterprise software application 100. For example, the cloud environment 110 can be in the form of a multi-tenant environment that can include a tenant (e.g., one or more user accounts sharing common privileges with respect to an instance of the enterprise software application 100) accessible by a computing system of a user associated with the instance of the enterprise software application 100, as well as other tenants accessible to computing systems of users associated with other instances of the enterprise software application 100. Here, each of the microservices includes a data repository 120 and an application programming interface (API) 121. The data repository 120 for each microservice 115 can facilitate the persistence of data objects within the microservice 115 in an independent manner from the other microservices 115. The API 121 for each microservice 115 allows the microservice 115 to communication with other microservices 115 of the enterprise software application 100, the centralized platform 125, users who are using the different services of the enterprise software application 100, and/or the like.

In various aspects, the centralized platform 125 is provided as a stand-alone process from the plurality of microservices 115. For example, the centralized platform 125 can also be provided as a microservice. The platform 125 is configured to capture and persist relationships between data objects across the plurality of microservices 115 in a manner that allows the various microservices 115 to operate independent or nearly independent of each other. According to various aspects, the platform 125 uses a graph data structure such as a graph database in capturing and persisting the relationships between the different data objects. Here, the graph data structure may include one or more graph data representations used in representing the various data objects and relationships that exist between the data objects, as well as attributes of the data objects and relationships.

The plurality of microservices 115 can make use of data object types that are common across more than one microservice 115. For instance, in the example involving the organization providing the enterprise software application of data privacy services, a common data object type that may be found over the different services provided through the microservices 115 is a “data asset” that makes use of personal data. For example, a data asset may represent hardware or software, such as a server, database, software application, and/or the like, that collects, transfers, stores, and/or processes personal data. Accordingly, a user may use a data asset internally to process personal data (e.g., a system that uses a shipping address to generate a shipping label) and a third-party vendor used by the user may use a data asset internally to store personal data (e.g., a database that stores the shipping address). Therefore, in the example, the data asset may be viewed as a data object type that is commonly represented in both the microservice 115 for the management of policy governance and compliance service and the microservice 115 for the vendor risk management service.

In various aspects, the graph data structure can include one or more first graph data representations (referred to herein as a schema graph representation) to capture and persist the different data object types that may be found/represented across the different microservices 115. In addition, different relationship types between data object types may exist across the different microservices 115. For example, the third-party vendor's database that stores the shipping address may transfer the shipping address to the user's system that makes use of the shipping address to generate the shipping label. Here, the database may transfer the shipping address via an electronic data interchange (EDI) that occurs over a secure network. Therefore, a “transfer to” may be viewed as a relationship type that can exist between the two data object types. Accordingly, the schema graph representation can capture and persist these different relationship types.

In various aspects, the graph data structure can include one or more second graph data representations (referred to herein as an operations graph representation) to capture and persist specific instances of the different data object types that exist (are represented) within the different microservices 115, as well as instances of relationship types that exist between the instances of the different data object types. Returning to the example involving the organization providing the enterprise software application of data privacy services, a first specific instance of a “data asset” would be the user's system that generates the shipping label using the shipping address that exists (is represented) in the microservice for the management of policy governance and compliance service and a second specific instance of a “data asset” would be the third-party vendor's database used for storing the shipping address that exists in the microservice for the vendor risk management service. Therefore, an instance of the relationship type “transfer to” would be the EDI of the shipping address that takes place between the system and database. Here, the operations graph representation also captures and persists the instance of the “transfer to.”

In various aspects, the platform 125 is configured so that the graph data structure is maintained independently (externally) of the various microservices 115. Such a configuration can allow for the plurality of microservices 115 to remain independent of each other, while the graph data structure is used to represent the relationships that exist between the data (data objects) of the different microservices 115. As result, the plurality of microservices 115 can still be maintained, updated, enhanced, configured, and/or the like separate from one another.

In various aspects, the platform 125 provides capabilities to allow users (e.g., personnel thereof) to conduct various types of analysis (e.g., queries) on the data that exists across the different microservices 115 due to the schema graph representation and the operations graph representation capturing and persisting data object types, relationship types, instances of data object types, and instances of relationship types for the different microservices 115. In some aspects, the platform 125 can provide a visual representation of the schema graph representation (portion thereof) displaying data object types, as well as the relationship types that may exist between the data object types. The platform 125 can allow a user to construct a query by traversing the visual representation of the schema graph representation to select (e.g., click on) the data object types of interest and relationship types of interest between the selected data object types. In addition, the platform 125 can allow the user to identify properties for various attributes of the selected data object types and/or relationship types to identify query input and/or output parameters.

Once the user has traversed the schema graph representation as desired, the platform 125 can generate a query that then traverses the operations graph representation and returns the results of the query to the user. In some aspects, the platform 125 provides a second visual representation of the operations graph representation (portion thereof) that includes the results providing instances of data object types and instances of relationship types found in one or more of the microservices 115 based at least in part on the generated query. In addition, the platform 125 in some aspects can query the data repositories 120 of the individual microservices 115 to gather further data on the instances of the data objects.

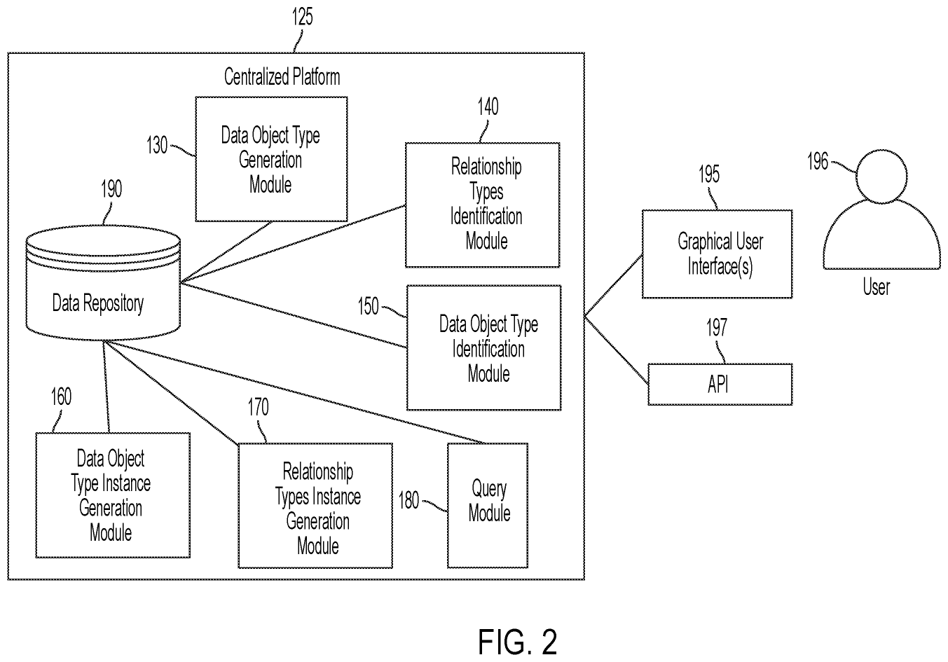

FIG. 2 depicts an example of the centralized platform 125 that is available through the enterprise software application 100 according to various aspects. Here, the platform 125 includes a data repository 190 used in storing the graph data structure. The platform's 125 use of the data repository 190 in storing the graph data structure can allow the graph data structure to be maintained in manner that is separate and independent of the plurality of microservices 115.

In various aspects, the platform 125 is provided through one or more computing systems that include software components and/or hardware components. In some aspects, a data object type generation module 130 executed by the platform 125 is used in creating custom data object types. An example of a custom data object type is a data object type created within a tenant and that is inaccessible to some or all of the other tenants in the cloud environment 110. In additional or alternative aspects, a relationship types identification module 140 executed by the platform 125 is used in identifying a relationship type that may exist between data object types. In additional or alternative aspects, a data object type identification module 150 executed by the platform 125 is used in providing data object types for a microservice 115. In additional or alternative aspects, a data object type instance generation module 160 executed by the platform 125 is used in generating an instance of a data object. In additional or alternative aspects, a relationship types instance generation module 170 executed by the platform 125 is used in generating an instance of a relationship. In additional or alternative aspects, a query module 180 executed by the platform 125 is used in generating a query.

In various aspects, the platform 125 provides a service that is accessible by a user 196 (e.g., a device associated with the user) that allows the user 196 to perform certain functionality. For example, a user 196 (e.g., personnel thereof) may access the service to create, within a tenant, a custom data object type (via the data object type generation module 130) to be made available through one or more microservices 115 supporting one or more services of the enterprise software application 100. Here, the platform 125 may provide the user 196 with one or more graphical user interfaces 195 (e.g., webpages) to access the service and corresponding functionality. In addition, the platform 125 includes an application programming interface (API) 197 that the platform 125 can utilize in communicating with the plurality of microservices 115.

### Data Object Type Generation Module

In various aspects, the platform 125 may provide a number of base data object types and/or relationship types “out of the box” that can be used in building instances of data object types and/or instances of relationship types. However, in additional or alternative aspects, the platform 125 allows for a user to generate a custom data object type and/or relationship type that is not necessarily found in the base data object types and/or relationship types. For instance, returning to the example involving the organization providing the enterprise software application 100 having a number of data privacy services, a user may be using a data mapping service to map various personal data the user is using in its internal processing and has a need for a data object type not found in the base data object types to represent individuals (e.g., privacy officers) who are required to approve the use of a particular data asset in collecting, transferring, storing, processing, and/or the like certain personal data. Therefore, the user may need to generate a custom data object type to be used in representing such individuals. It is noted that in some aspects base data object types and/or relationship types may not be provided at all, and the user may be required to generate each of the data object types and/or relationship types that are applicable.

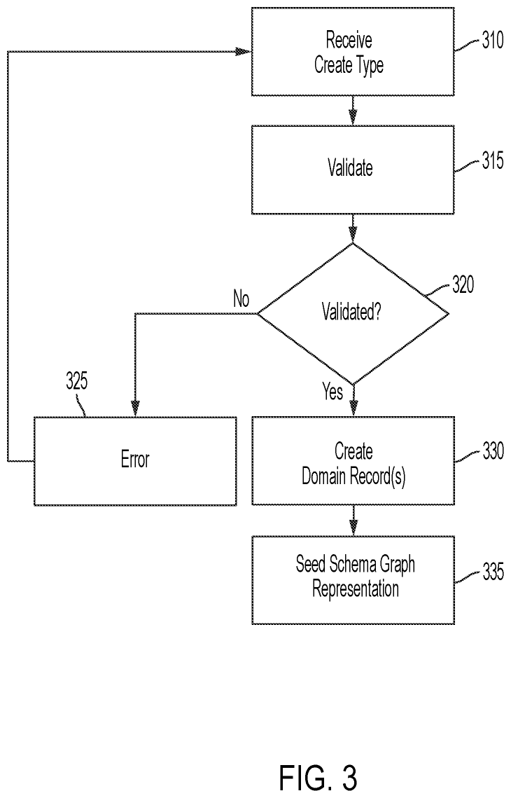

Turning now to FIG. 3, additional details are provided regarding a data object type generation module 130 for generating a data object type in accordance with various aspects of the disclosure. The example process shown in FIG. 3 may correspond to operations carried out by a processor of computing hardware such as, for example, a server device described further herein, as it executes the data object type generation module 130.

Here, the platform 125 may provide a user (personnel thereof) with a graphical user interface (GUI) to enter information needed in generating the data object type and to initiate the creation of the data object type. The platform 125 receives information entered by the user via the GUI and invokes the data object type generation module accordingly. The process involves the data object type generation module receiving a request to create a data object type in Operation 310. The request includes various information (e.g., the information provided by the user via the GUI) used in generating the data object type such as, for example, a name of the data object type, a description of the data object type, one or more attributes of the data object type, and/or the like.

The one or more attributes for the data object type may include one or more default attributes for the data object type, as well as one or more custom attributes defined by the user. In various aspects, the attributes identify characteristics associated with the data object type. For example, if the new data object type is to be used to represent a privacy officer within the user, then an attribute may be first name, last name, job title, and/or the like. Accordingly, the attributes may then be populated with properties when an instance of the data object type is generated. For example, if an instance of the privacy officer data object type is generated, the actual name of the privacy officer may be used to populate the first name and last name attributes. In some aspects, the platform 125 may automatically populate one or more of the default attributes with a property such as a data object type identifier, one or more data-related process identifiers, user identifier, and/or the like.

The process continues with the data object type generation module 130 validating the data object type in Operation 315 and determining whether the data object type has been validated in Operation 320. In some aspects, this operation can entail ensuring the data object type is unique and does not already exist in the graph data structure and/or the associated microservices 115. For example, the data object type generation module 130 may query the schema graph representation using information provided for the data object type to determine whether the information may be associated with another data object type that already exists in the schema graph representation. If so, then the data object type generation module 130 may return an error message to the user in Operation 325. Similarly, the data object type generation module 130 may query the data schemas for one or more microservices 115 using information provided for the data object type to determine whether the information may be associated with another data object type used within the microservices 115. Such information may include, for example, the name of the data object type, a description of the data object type, a purpose of the data object type, and/or the like.

Once the data object type has been validated, the data object type generation module 130 creates one or more domain records for the data object type in Operation 330. In various aspects, this particular operation involves adding the data object type to the appropriate data schemas for the one or more microservices 115 associated with the data object type. In some aspects, one or more placeholders (e.g., fields) are provided in the data schema for each microservice 115 that are then used for seeding (e.g., installing, recording, and/or the like) the new data object type into the data schema. The data object type generation module 130 can create the one or more domain records by submitting one or more data-related process requests to the microservices 115 (e.g., to one or more function(s) found in a library of each of the appropriate microservices 115) and each of the associated microservices 115 records the data object type in the data schema by using the placeholder(s) found in the schema. As a result of carrying out this operation, the new data object type is encapsulated within each of the appropriate microservices 115, which can allow each microservice 115 to recognize the new data object type and still remain independent of the other microservices 115.

The data object type generation module 130 seeds (e.g., installs, records, and/or the like) the data object type in the schema graph representation in Operation 335. According to various aspects, the data object type generation module 130 performs this particular operation by publishing a schema graph request to a management service that can be provided through the platform 125 for the graph data structure. The schema graph request can provide the data for the data object type and attributes. In turn, the management service generates a data object type node in the schema graph representation for the data object type and as a result, the data object type now exists within the data schemas of the appropriate microservices 115, as well as the graph data structure. Accordingly, the data object type can now be used within the appropriate microservices 115 and relationship types that may exist between the data object type and other data object types found in the same microservice 115 and/or other microservices 115 may be persisted in the graph data structure.

Although not specifically shown in FIG. 3, the data object type generation module 130 (or another module) in some aspects allows a user to edit and/or delete a data object type. The platform 125 can provide a GUI that allows for the user to select a data object type for one or more microservices 115 and then edit and/or delete attributes for the data object type. In addition, the GUI can allow the user to delete the data object type entirely, resulting in the removal of the data object type from the data schemas of the associated microservices 115 and the schema graph representation of the graph data structure.

In addition, although not shown in a specific figure, the platform 125 according to various aspects can include a module to generate relationship types as well. Such a module functions in a similar manner as the data object type generation module 130. For example, a relationship type generation module may be configured to generate default attributes for a relationship type, as well as allow a user to define custom attributes for the relationship type. In some aspects, the relationship type generation module is not configured to seed the relationship type into the data schemas for the associated microservices 115. Instead, the relationship type generation module only seeds in the schema graph representation so that it persists and may be used in generating instances of the relationship type found to exist between instances of data object types. Such a configuration can allow for relationships to exist between instances of data objects found in different microservices 115, while allowing the microservices 115 to remain virtually independent.

### Relationship Types Identification Module

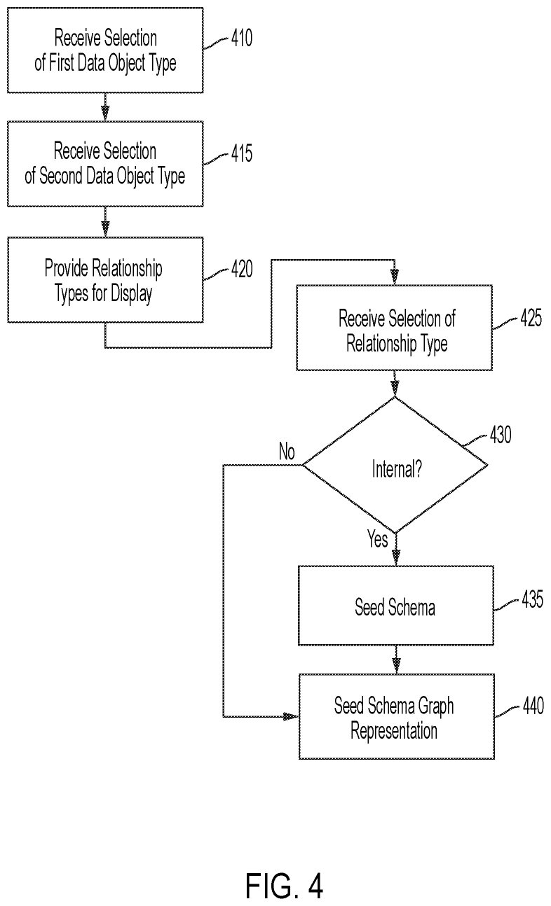

Turning now to FIG. 4, additional details are provided regarding a relationship types identification module 140 for identifying a relationship type that may exist between two data object types in accordance with various aspects of the disclosure. The example process in FIG. 4 may correspond to operations carried out by a processor of computing hardware such as, for example, a server device described further herein, as it executes the relationship types identification module 140.

As previously noted, the platform 125 can provide “out of the box” data object types and/or relationship types. Accordingly, certain relationship types may exist between any two data object types. For example, a data asset such as a database may store certain data elements. Therefore, this relationship may be represented as the relationship type “contains” that may exist between the object type “data asset” and the data object type “data element.” Similarly, the relationship type “uses” may exist between the data object type “processing activity” and the data object type “data asset” to represent an activity that may involve the processing of data using a data asset.

However, instances may occur when a relationship type that can exist between two data object types is not identified in the base set of relationship types. For example, a user may generate a custom data object type such as a “privacy officer” data object type. However, since the data object type is new, no relationship types that can exist between the custom data object type and other data object types are identified in the base set of relationship types. Therefore, in such an instance, the user may wish to identify one or more relationship types between the custom data object type and other data object types. In various aspects, the relationship types identification module 140 provides the user with such functionality to identify the one or more relationship types between the custom data object type and other data object types.

The process involves the relationship types identification module 140 receiving a selection of a first data object type in Operation 410 and a second data object type in Operation 415. In some aspects, the platform 125 provides a user (e.g., personnel thereof) with a GUI that allows the user to select the first and second data object types. For instance, the GUI may provide a listing of the various data object types from which the user can select the two data object types of interest. In additional or alternative aspects, the GUI may allow the user to filter available data object types to help facilitate quicker selection of the data object types of interest. For example, the GUI may allow the user to filter the available data object types based at least in part on a microservice 115 (e.g. and/or associated service). Here, the relationship types identification module 140 may invoke a data object type identification module 150 and the data object type identification module 150 may allow the user to select a microservice 115 to display the data object types associated with the microservice 115 and select a data object type of interest from the data object types displayed on the GUI.

Once the user has selected the first and second data object types, the relationship types identification module 140 provides the relationship types for display on the GUI in Operation 420. In some aspects, the relationship types identification module 140 uses a set of rules in determining which of the relationship types may be displayed for selection by the user based at least in part on the first and second data object types. For example, if one of the first or second data object types is “privacy officer,” then the relationship types identification module 140 may not display the relationship type “transfer to” since a privacy officer can neither “transfer” data to another nor have data “transferred” to him or her. In various aspects, the platform 125 can define (e.g., store) the set of rules (e.g., a rules-based model) that can be used by the relationship types identification module 140 in identifying which options of relationship types to display for the user to choose from.

Accordingly, the GUI can receive a selection made by the user of one of the relationship types displayed on the GUI and the relationship types identification module 140 receives the selected relationship type in Operation 425. For example, the first data object type may be “privacy officer” and the second data object type may be “processing activity.” Here, the user may wish to set up a relationship type of “authorizes” that can exist between the two data object types to represent instances in which a privacy officer is required to authorize a particular processing activity that is using personal data. Therefore, in this instance, the GUI may receive a selection made by the user of the relationship type “authorizes” and the relationship types identification module 140 receives the selection accordingly.

At this point, the relationship types identification module 140 determines whether the relationship type that can exist between the first and second data object types represents a type of relationship that can exist internally within one or more microservices 115 in Operation 430. For example, both of the first and second data object types may be associated with a common microservice 115. If this is the case, then the relationship types identification module 140 seeds the existence of the relationship type in the data schema for the appropriate microservice 115 in Operation 435. For example, the relationship types identification module 140 can seed the existence of the relationship type into one or more placeholders found in the schema. This operation may involve recording information on the relationship type in the one or more placeholders so that the relationship type is represented in the schema. As a result, the microservice 115 can then use the relationship type internally within the microservice 115 to represent instances of the relationship type existing between instances of the first and second data object types found in the microservice 115. However, with that said, the relationship types identification module 140 can be configured in particular aspects not to perform such an operation to seed the data schema of the microservice 115.

In Operation 440, the relationship types identification module 140 seeds the schema graph representation of the graph data structure. In various aspects, the relationship types identification module 140 performs this particular operation by publishing a schema graph request to the management service for the graph data structure and the management service generates an edge in the schema graph representation for the relationship type between the data object type node found in the schema graph representation for the first data object type and the data object type node found in the schema graph representation for the second data object type. Accordingly, the platform 125 can provide a visual representation displaying the two nodes and the edge to a user who is interest in identifying instances of the two data object types in which an instance of the relationship type actually exists between the two instances and/or who is interest in generating a query to traverse the nodes and edges of instances of the two data object types and relationship type that exist to return desired data.

### Data Object Type Identification Module

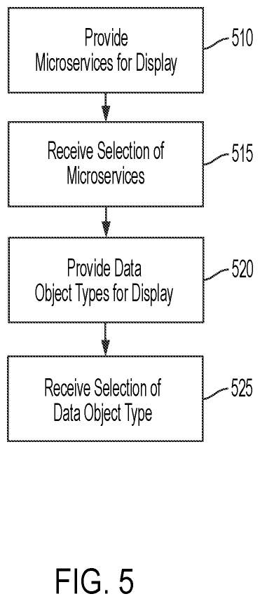

Turning now to FIG. 5, additional details are provided regarding a data object type identification module 150 for identifying a data object type of interest in accordance with various aspects of the disclosure. Accordingly, the example process shown in FIG. 5 may correspond to operations carried out by a processor of computing hardware such as, for example, a server device described further herein, as it executes the data object type identification module 150.

The process involves the data object type identification module 150 providing the microservices 115 found in the ecosystem for display on a GUI to the user in Operation 510. As previously discussed, filtering criteria may be used in various aspects to enable the user to identify a data object type of interest more quickly in establishing the relationship types that may exist between the data object type and another data object type. In particular aspects, the data object type identification module 150 uses the microservices 115 to filter the data object types, although the identify data object type identification module 150 can use other filtering criteria in additional or alternative aspects.

Accordingly, the GUI can display the microservices 115 to the user and the user selects a microservice 115 of interest. In turn, the data object type identification module 150 receives the selection of the microservice 115 in Operation 515 and provides the data object types associated with the selected microservice 115 for display on the GUI in Operation 520. In some aspects, the data object type identification module 150 can identify the data object types to display by traversing the schema graph representation to identify the data object type nodes found in the schema graph representation for those data object types that are associated with the selected microservice 115. For example, such nodes may be identified as having an attribute with a property identifying the microservice 115.

In Operation 525, the data object type identification module 150 receives a selection made by the user of a data object type of interest. Accordingly, the selection of the identify data object type can then be used in further operations. For example, as previously discussed, the relationship types identification module 140 can use the selected data object type in identifying relationship types that may exist between the selected data object type and other data object types. While in another example, a GUI provided through the platform 125 can display the selected data object type, along with its attributes, so that the data object type may be updated, revised, modified, and/or the like.

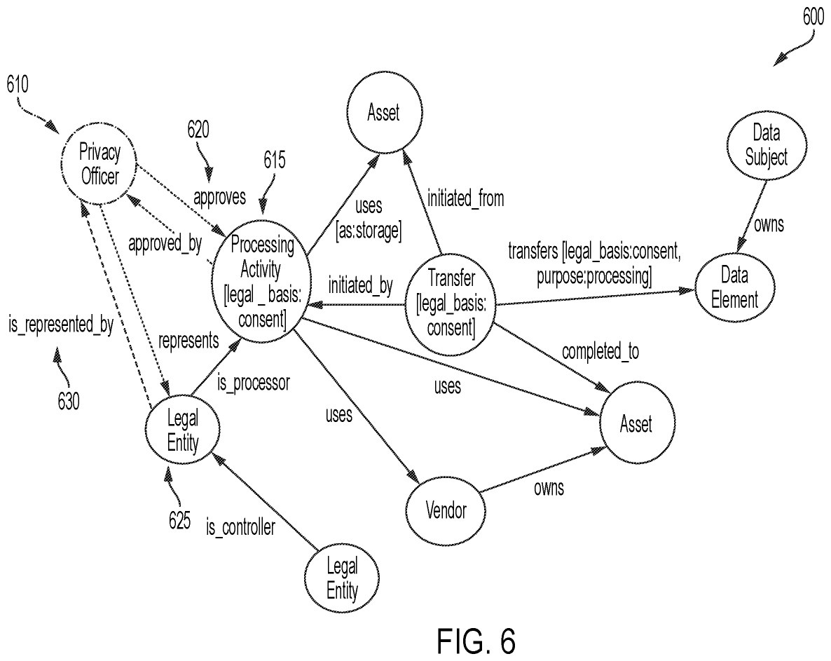

Turning briefly to FIG. 6, an example of a visual representation 600 is provided for a custom data object type “privacy officer” (node) 610 that has been added to a workflow for providing consent to having a base data object type “processing activity” 615 make use of personal data. Here, a custom relationship type “approves/approved by” (edges) 620 has been added to represent that the privacy officer is to provide approval of the processing activity using the personal data. In this particular instance, the custom relationship type 620 is represented by two edges (e.g., bi-directional) to facilitate queries that may involve retrieving data (answering) in different forms (different questions) and avoiding traversing into a node that may lead to inefficiencies. In addition, the custom data object type “privacy officer” 610 is connected to another base data object type “legal entity” (node) 625 through a custom relationship type “represents/is represented by” (edges) 630. Accordingly, the data object types 610, 615, 625 may be associated with different microservices 115. For example, the custom data object type “privacy officer” 610 and base data object type “legal entity” 625 may be associated with a microservice 115 for a service provided to users in managing privacy risk in using personal data. While the base data object type “processing activity” may be associated with a microservice 115 for a service provided to users for mapping internal and external processes, systems, activities, and/or the like that make use of personal data. Thus, in various aspects, the platform 125 allows for the users to identify and persist relationships that exist across these two microservices 115.

### Data Object Type Instance Generation Module

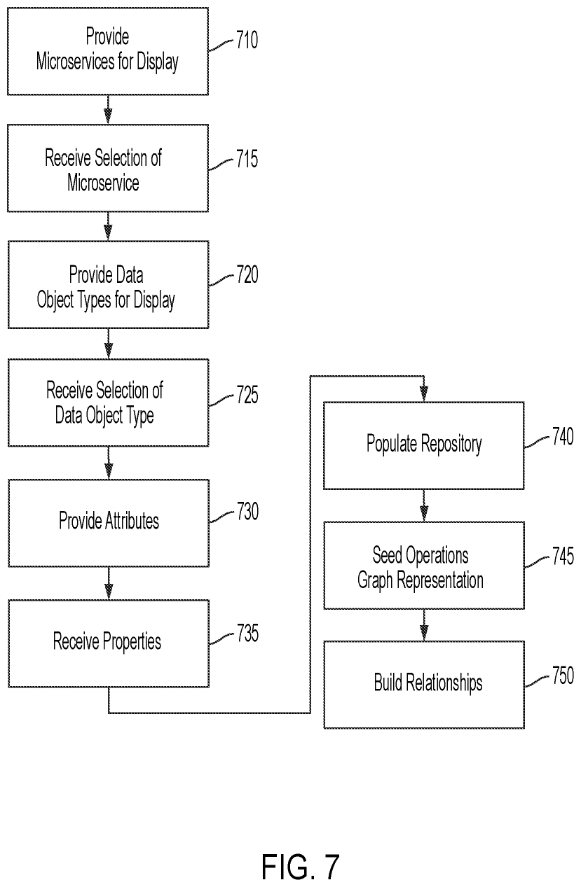

Turning now to FIG. 7, additional details are provided regarding a data object type instance generation module 160 for generating an instance of a data object type in accordance with various aspects of the disclosure. Accordingly, the example process shown in FIG. 7 may correspond to operations carried out by a processor of computing hardware such as, for example, a server device described further herein, as it executes the data object type instance generation module 160.

The process involves the data object type instance generation module 160 providing the microservices 115 for display on the GUI in Operation 710. Here, the GUI may allow the user (e.g., personnel thereof) to select one of the microservices 115 as the service with which the user would like the generated instance of the data object type to be associated. For instance, returning to the example in which the user would like to generate an instance of a “privacy officer,” the user may select the privacy risk management service of the enterprise platform.

As a result, the data object type instance generation module 160 receives the selection of the microservice 115 in Operation 715 and provides the data object types associated with the selected microservice 115 for display on the GUI in Operation 720. Again, the GUI is configured to allow the user to select a data object type of interest. For example, the GUI may provide a listing of the data object types associated with the selected microservice 115 from which the user may select the desired data object type. Here, the GUI may provide information along with each of the data object types to aid the user in selecting the desired data object type such as a name of the data object type, a description of the data object type, relationship types associated with the data object type, and/or the like. In additional or alternative aspects, the GUI may provide a visual representation of the data object types associated with the selected microservice 115. For example, the GUI may display nodes representing different data object types along with edges representing relationship types that can exist between two data object types. Such a representation may help the user more quickly identify and build out various instances of data object types within a microservice 115.

Once the user has selected a particular data object type, the data object type instance generation module 160 receives the selection in Operation 725 and provides the attributes for the selected data object type for display on the GUI in Operation 730. As previously discussed, each data object type may have one or more attributes associated with the data object type that represent different characteristics of the data object type. For instance, returning again to the example of the data object type “privacy officer,” this particular data object type may have the attributes first name, last name, organizational unit, division, and/or the like. Therefore, the user can provide properties for one or more of the attributes through the GUI to define a specific occurrence of the data object type. For example, the user can provide the property “Michael” for the first name attribute, “Smith” for the last name attribute, “legal” for organizational unit, “North America” for division, and so forth.

Once the user has provided the properties for the different attributes, the data object type instance generation module 160 receives the properties for the different attributes in Operation 735 and records one or more data entries (e.g., data records) in the data repository 120 for the microservice 115 with the instance of the data object type in Operation 740. In various aspects, the data object type instance generation module 160 can use the seeding of the data object type in the data schema of the microservice 115 to assist in recording the instance of the data object type in the data repository. This can allow for segregation to be maintained between the different microservices 115 to enable autonomous development of functionality within the different microservices 115.

In addition, the data object type instance generation module 160 seeds the operations graph representation of the graph data structure with the instance of the data object type in Operation 745. In particular aspects, the data object type instance generation module 160 performs this particular operation by publishing an operations graph request to the management service that provided through the platform 125 for the graph data structure and the management service generates a node to represent the instance of the data object type in the operations graph representation. As a result, the instance of the data object type is now also represented in a centralized location (service) for the various microservices 115 so that relationships between the instance of the data object type and other instances of data object types may be identified and persisted, even those relationships that exist between the instance of the data object types and other instances of data object types that span over multiple microservices 115.

In Operation 750, the data object type instance generation module 160 builds the relationships that exist between the instance of the data object type and other instances of data object types. In particular aspects, the data object type instance generation module 160 performs this operation by invoking a relationship types instance generation module 170. As discussed further herein, the relationship types instance generation module 170 provides functionality to allow the user to select various instances of data object types that may be found in the same microservice 115 or different microservices 115 and identify instances of relationship types that exist between the generated instance of the data object type and the selected instances of data object types. Accordingly, the relationship types instance generation module 170 can seed the instances of relationship types in the operations graph representation of the graph data structure to persist the relationships. As a result, the persisted relationships can then be used in conducting queries of the data object types that may span over multiple microservices 115.

Although not specifically shown in FIG. 7, the data object type instance generation module 160 can be configured (or another module can be configured) according to various aspects to allow a user to edit and/or delete an instance of a data object type. In some aspects, the platform 125 can provide a GUI that allows for the user to select an instance of a data object type and then edit and/or delete the properties of attributes and/or instances of relationship types for the instance. In addition, the GUI can allow the user to delete the instance entirely, resulting in the removal of the instance and corresponding instances of relationship types from the data repository 120 of associated microservice 115 and the operations graph representation of the graph data structure.

### Relationship Types Instance Generation Module

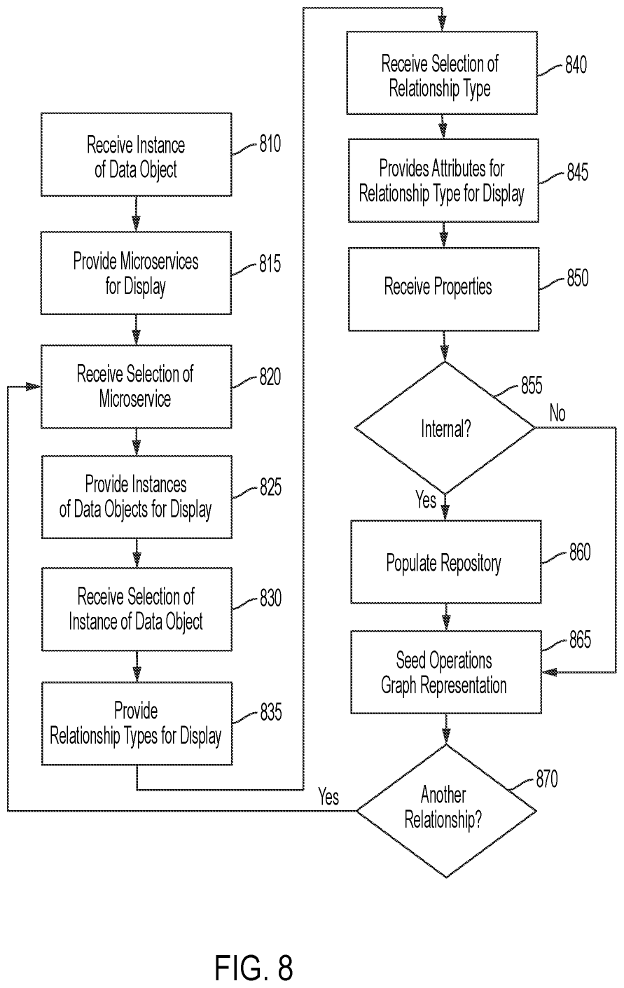

Turning now to FIG. 8, additional details are provided regarding a relationship types instance generation module 170 for generating instances of relationship types between instances of data object types in accordance with various aspects of the disclosure. Accordingly, the flow diagram shown in FIG. 8 may correspond to operations carried out by a processor of computing hardware such as, for example, a server device described further herein, as it executes the relationship types instance generation module 170.

The process involves the relationship types instance generation module 170 receiving an instance of a data object type in Operation 810. In some aspects, the platform 125, based on input provided by a user, may have generated a new instance of a data object type as discussed above, and the data object type instance generation module 160 may have invoked the relationship types instance generation module 170 and created the new instance of the data object type. In turn, the relationship types instance generation module 170 provides the microservice 115 for display on the GUI to the user in Operation 815. In some aspects, the relationship types instance generation module 170 provides a listing of the microservices 115 to display on the GUI from which the user can select a microservice 115 of interest. In particular aspects, the listing of microservices 115 can be limited to those microservices 115 that have instances of data object types with relationship types defined that may exist between the instances and the instance of the data object type. For example, if the instance of the data object type involves an instance of a privacy officer data object type, then the microservices 115 provided to the user are only those microservices 115 that have instances of data object types that may have relationships defined with a privacy officer. In additional or alternative aspects, the relationship types instance generation module 170 may provide a visual representation of the microservices 115 having related data object types to display on the GUI from which the user may then select a particular microservice 115 to then drill down into the related data object types found in the selected microservice 115.

The relationship types instance generation module 170 receives a selection of a microservice 115 in Operation 820 and provides instances of the related data object types for display on the GUI in Operation 825. In some aspects, the relationship types instance generation module 170 provides the instance of the data object type and the instances of the related data object types found in the selected microservice 115 as a visual representation, using nodes to represent the instance of the data object type and the instances of the related data object types and using edges between the instance of the data object type and each of the instances of the related data object types to represent the different relationship types that may exist between the instance of the data object type and the instances of the related data object types.

The GUI can display the instances of the related data object types along with information (e.g., one or more properties) to enable the user to distinguish between the different instances. The GUI allows for the user to select one of the instances of the related data object types to generate an instance of a relationship type that exists between the instance of the data object type and the selected instance of the related data object type. Once selected, the relationship types instance generation module 170 receives the selection of the instance of the related data object type in Operation 830 and provides the relationship types that may exist between the instance of the data object type and the selected instance of the related data object type in Operation 835. For example, the edge connecting the instance of the data object type and the selected instance of the related data object type may provide some type of mechanism, such as a dropdown menu, that displays the relationship types that may exist between the instance of the data object type and the selected instance of the related data object type and allows for the user to identify the particular relationship type that exists between the instance of the data object type and the selected instance of the related data object type.

As a specific example, if the instance of the data object type is an instance of a privacy officer, then the visual representation can display a node representing the instance of the privacy officer and multiple nodes representing instances of processing activities that the privacy officer may be responsible for reviewing for the use of personal data. Edges may be provided between the node representing the instance of the privacy officer and the nodes representing the instances of the processing activities. Accordingly, The visual representation can allow the user to select a node representing a particular instance of a processing activity and then click on the edge to display a dropdown menu from which the user can then select the relationship type that exists between the instance of the privacy officer and the instance of the processing activity (e.g., “approves/approved by”).

Once the user had identified the instance of the relationship type, the relationship types instance generation module 170 receives the selection of the relationship type in Operation 840 and provides the attributes for the selected relationship type for display on the GUI in Operation 845. As a result, the user may then define (enter) properties for various attributes of the selected relationship type if appropriate. For example, an attribute of the relationship type “approves/approved by” may be a date that the privacy officer provided approval. Therefore, the user may populate the attribute with the actual date on which approval was provided by the privacy officer.

Once the user has defined the appropriate properties for the instance of the relationship type, the relationship types instance generation module 170 receives the properties in Operation 850. In various aspects, the relationship types instance generation module 170 determines whether the instance of the relationship type exists internally within a microservice 115 in Operation 855. That is to say, the relationship types instance generation module 170 determines whether the instance of the data object and the selected instance of the related data object exist in the same microservice 115. If so, then the relationship types instance generation module 170 records one or more data entries (e.g., data records) for the instance of the relationship type in the data repository 120 for the appropriate microservice 115 in Operation 860. Again, the relationship types instance generation module 170 may use the relationship type seeded in the data schema for the appropriate microservice 115 to assist in recording the data entries for the instance of the relationship type in the data repository 120. It is noted according to some aspects, the relationship types instance generation module 170 may not perform this particular operation and instead the instance of the relationship may only be persisted in the operations graph representation of the graph data structure.

In Operation 865, the relationship types instance generation module 170 seeds the instance of the relationship type in the operations graph representation. In various aspects, the relationship types instance generation module 170 performs this particular operation by publishing an operations graph request to the management service for the graph data structure and the management service then generates one or more edges for the instance of the relationship type in the operations graph representation. As a result, the instance of the relationship type is now also represented and persisted in a centralized location (service) for the various microservices 115.

At Operation 870, the relationship types instance generation module 170 determines whether the user would like to generate another instance of a relationship type for the instance of the data object type. If so, then the relationship types instance generation module 170 returns to Operation 820 to receive a selection of a microservice 115 (which may be the same or a different microservice 115) and performs the operations as just discussed to generate the next instance of a relationship type for the instance of the data object type.

Once the relationship types instance generation module 170 has generated the appropriate instances of relationship types for the instance of the data object type, the relationships that exist between the instances of the data object type and other instances of data object types are persisted and can be used in querying data for the instance of the data object type, instances of the relationship types, and/or other instances of data object types. As discussed further herein, such queries may be designed on the fly and executed on the operations graph representation. Accordingly, since the operations graph representation includes edges that represent the various instances of relationship types that exist between different instances of data object types, the platform 125 can execute these queries to retrieve data on instances of data object types that span different microservices 115 in an effective, efficient, and timely manner.

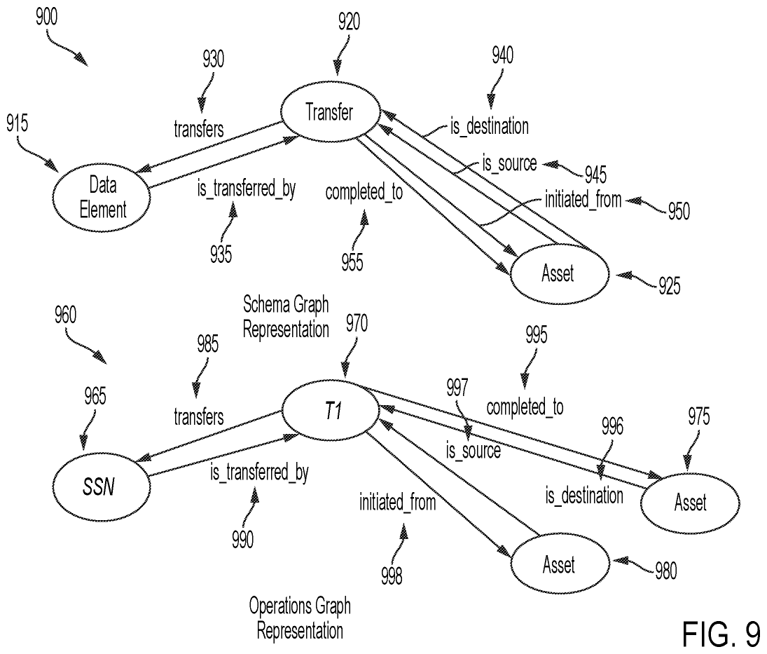

Turning briefly to FIG. 9, an example is provided of a portion of the schema graph representation 900 that includes three nodes 915, 920, 925 representing the three different data object types “data element,” “transfer,” and “asset.” In this example, the portion of the schema graph representation 900 includes two edges 930, 935 that represent the relationship type “transfers/is transferred by” that can exist between a data element and a transfer. Likewise, the portion of the schema graph representation 900 includes two edges 940, 945 that represent the relationship type “destination/is source” that can exist between a transfer and an asset. In addition, the portion of the schema graph representation 900 includes two edges 950, 955 that represent another relationship type “initiated from/completed to” that can exist between a transfer and an asset. Accordingly, these data object types and relationship types can then be used in generating instances of the data object types and relationship types that are populated in the operations graph representation.

For example, a portion of the operations graph representation 960 may represent instances of the different data object types and relationship types. Here in the example, the portion of the operations graph representation 960 shown in FIG. 9 includes a first node 965 representing an instance of a data element in the form of a social security number. The portion of the operations graph representation 960 also includes a second node 970 for an instance of a transfer in the form of T1. The portion of the operations graph representation 960 also includes third and fourth nodes 975, 980 for instances of assets. The portion of the operations graph representation 960 includes two edges 985, 990 representing an instance of the relationship type “transfers/transferred by” connecting the nodes 965, 970 for the instance of the data element and the instance of the transfer. In addition, the portion of the operations graph representation 960 includes two edges 995, 996 representing an instance of the relationship type “completed to/is destination” connecting the nodes 970, 975 for the instance of the transfer and one of the instances of the assets. Further, the portion of the operations graph representation 960 includes two edges representing an instance of the relationship type “is sourced/initiated from” 997, 998 correcting the nodes 970, 980 for the instance of the transfer and the instance for the other asset. Accordingly, this portion of the operations graph representation 960 represents a transfer of a social security number that involves the first asset transferring the social security number that is completed to the second asset.

### Query Module

In various aspects, the platform 125 enables a user to conduct an analysis on data that may span multiple microservices 115. In some aspects, the platform 125 enables a user to conduct queries on the data through the graph data structure. Because the graph data structure facilitates the persistence of relationships between data objects used within the individual microservices 115, the platform 125 can allow for a user to construct a query that may return data results from multiple microservices 115. Furthermore, in some aspects, the platform 125 can do so while not affecting the autonomy of the multiple microservices 115.

In various aspects, the platform 125 provides a novel GUI that provides a visual representation of at least a portion of the schema graph representation from which a user (e.g., personnel thereof) can traverse to build a query traversal specification to find the answer to a specific question. For example, a user may be interested in finding out the privacy officers of the user who have approved cross-region transfers of personal data. The platform 125 can then use the query specification, along with the knowledge of the schema graph representation, to build out a traversal of the operations graph representation. The visual representation of the portion of the schema graph representation can provide the user with a model that allows the user to build out the traversal as an exercise similar to what would be performed on a white board. Once built, the platform 125 can generate a query on the fly and execute the query to produce results. Here, the results can be returned in different formats. In some aspects, the results can be returned as a second visual representation that is displayed to the user similar in structure to the portion of the schema graph representation used in constructing the query specification. In additional or alternative aspects, the results can be returned in a file format such as JavaScript Object Notation (JSON).

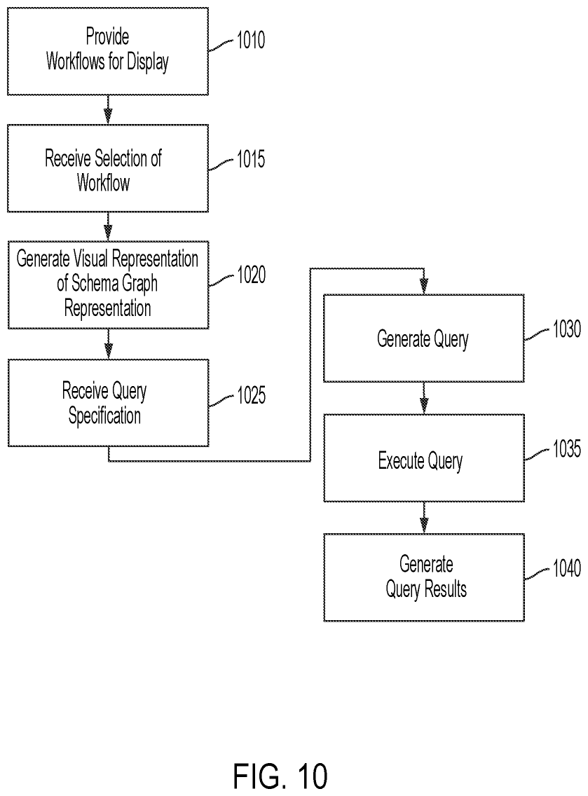

Turning now to FIG. 10, additional details are provided regarding a query module 180 for generating a query specification in accordance with various aspects of the disclosure. The example process shown in FIG. 10 may correspond to operations carried out by a processor of computing hardware such as, for example, a server device described further herein, as it executes the query module 180.

The process involves the query module 180 providing workflows for display on the GUI to the user in Operation 1010. In various aspects, workflows may be defined to better group data object types, relationship types, and instances thereof. For example, a first workflow may be defined that includes the data object types, relationship types, and instances thereof related to obtaining consent required for use of personal data, a second workflow may be defined that includes the data object types, relationship types, and instances thereof related to transfers of personal data, and so forth. Accordingly, the workflows associated with a particular data object type and/or relationship type may be defined as one or more attributes of the data object type and/or relationship type. Therefore, a particular data object type and/or relationship type may be associated with more than one workflow.

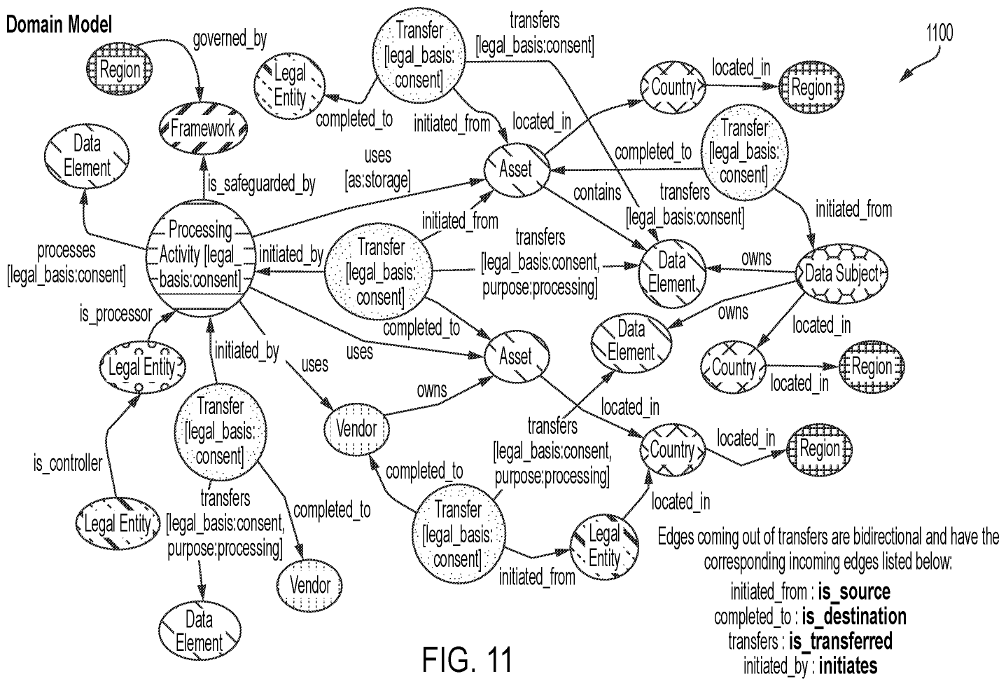

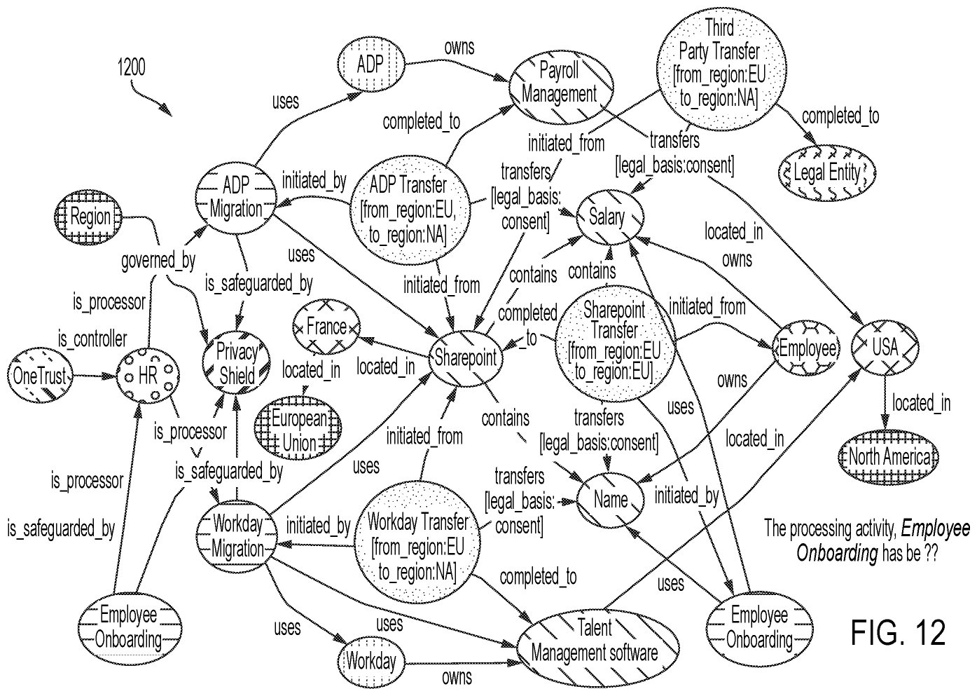

The selection of a particular workflow may help in identifying those data object types and/or relationship types that are more of interest to the user in constructing the query. For instance, if the user is interested in querying the privacy officers of the user who have approved cross-region transfers of personal data, then the user may select the legal consent workflow. For example, a model 1100 of such a workflow is shown in FIG. 11. In another instance, if the user is interested in querying intra- and inter-region transfers of employee information when a new employee is onboarded at the user, then the user may select the employee administrative workflow. For example, a model 1200 of such a workflow is shown in FIG. 12. In turn, the query module 180 receives the selection of the workflow in Operation 1015 and generates the visual representation of the portion of the schema graph representation for displaying on the GUI based at least in part on the selected workflow in Operation 1020. Accordingly, the portion of the schema graph representation includes those data object types and relationship types that are associated with the selected workflow.

The GUI allows the user to then traverse through the different data object types (nodes) and relationship types (edges) displayed in the visual representation to construct the query specification. In addition, the GUI allows the user to select properties for one or more attributes of the various data object types and/or relationship types that have been selected. For example, the user may identify a property for an attribute of a selected transfer data object type as being cross region. The property may then be used as a query parameter. In addition, the GUI allows the user to identify a data object type, relationship type, and/or attribute thereof as a desired result of the query such as, for example, first name and last name of a privacy officer. Accordingly, the visual representation may be configured to facilitate the user's identification of properties. For example, the visual representation may provide the attributes for a data object type or relationship type via dropdown menus to allow for the user to select a particular property. In another example, the visual representation may provide the attributes via freeform fields in which the user may then enter the properties.

Once the user has traversed the visual representation to construct the query specification, the query module 180 receives the query specification in Operation 1025. The query module 180 then constructs the graph query from the query specification in Operation 1030. For example, the query module 180 can construct a gremlin query, cypher query, PGQL query, GSQL query, and/or the like from the query specification. Once constructed, the query module 180 executes the query in Operation 1035. The query module 180 then executes the query on the operations graph representation to generate results for the query in Operation 1040. In some aspects, the query module 180 can execute a query on one or more of the data repositories 120 for corresponding microservices 115 to allow for additional data to be provided in the results.

Thus, in various aspects, the query module 180, the graph data structure in combination with the data repositories 120 for the individual microservices 115, and the visual representation of the data object types and relationship types corresponding to a workflow of interest can enable the user to construct a custom query on the fly to return desired results that can span across multiple microservices 115. Further, the capabilities of the platform 125 to generate custom data object types and/or relationship types, as well as generate instances of these custom data object types and/or relationship types, can enable the user to construct a custom query on the fly based at least in part on custom data object types and/or relationship types that may span across multiple microservices 115 without the need for the organization hosting the platform 125 (e.g., system administrators thereof) having to provide the individual microservices 115 involved in the query with the custom data object types, custom relationship types, and/or instances thereof.

### Example Technical Platforms

Aspects of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

Depending on the aspect, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

Depending on the aspect, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where aspects are described to use a computer-readable storage medium, other types of computer-readable storage media may be substituted for or used in addition to the computer-readable storage media described above.

As should be appreciated, various aspects of the present disclosure may also be implemented as methods, apparatus, systems, computing devices, computing entities, and/or the like. As such, aspects of the present disclosure may take the form of a data structure, apparatus, system, computing device, computing entity, and/or the like executing instructions stored on a computer-readable storage medium to perform certain steps or operations. Thus, aspects of the present disclosure may also take the form of an entirely hardware aspects, an entirely computer program product aspects, and/or aspects that comprise combination of computer program products and hardware performing certain steps or operations.

aspects of the present disclosure are described below with reference to block diagrams and flowchart illustrations. Thus, it should be understood that each block of the block diagrams and flowchart illustrations may be implemented in the form of a computer program product, an entirely hardware aspect, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some aspects, retrieval, loading, and/or execution may be performed in parallel such that multiple instructions are retrieved, loaded, and/or executed together. Thus, such aspects can produce specifically configured machines performing the steps or operations specified in the block diagrams and flowchart illustrations. Accordingly, the block diagrams and flowchart illustrations support various combinations of aspects for performing the specified instructions, operations, or steps.

### Example System Architecture

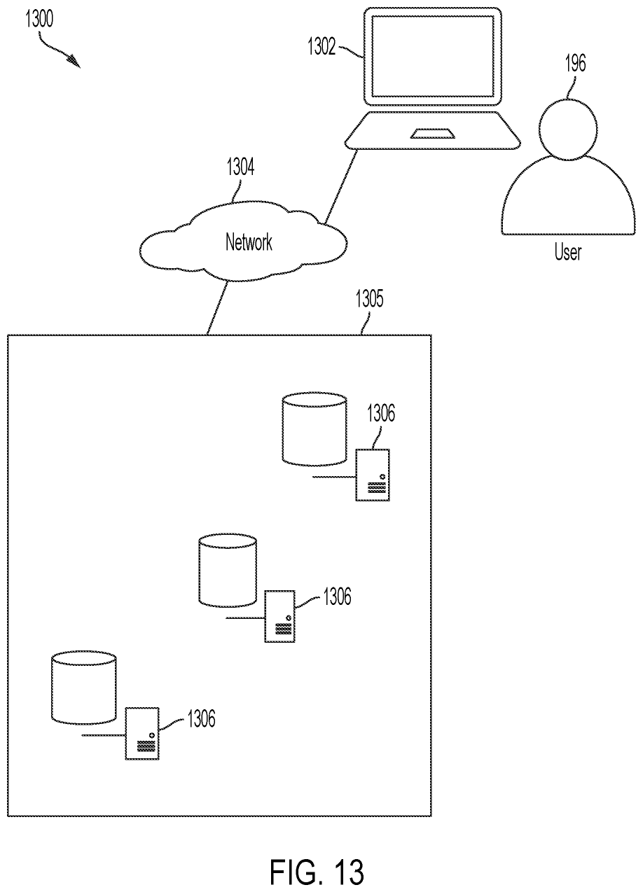

FIG. 13 depicts an example of a system architecture 1300 that can be used to execute implementations of various aspects of the present disclosure. The architecture 1300 includes one or more user devices 1302, a server system 1305 (which can be multiple server systems 1305 in some implementations), and a network 1304. The server system 1305 includes one or more server devices 1306. In various aspects, a user (personnel thereof) 196 can use a user device 1302 to interact with services provided through an enterprise software application 100 that is hosted by the server system 1305. For example, an entity such as organization can subscribe to one or more of the services provided through the enterprise software application 100 and become a “user” of the enterprise software application.

In various aspects, each server device 1306 may include at least one server and at least one data store. Here, the server devices 1306 may represent various forms of servers including, but not limited to a web server, an application server, a proxy server, a network server, and/or a server pool. The user device 1302 can include any appropriate type of computing device such as a server, a desktop computer, a laptop computer, a handheld computer, a tablet computer, a personal digital assistant (PDA), a cellular telephone, a network appliance, a smart phone, and/or the like.

Here, the user device 1302 can communicate with one or more of the server devices 1306 over the network 1304 to allow the user to perform functionality provided by the services. In addition, the user device 1302 can communication with one or more of the server devices 1306 over the network 1304 to allow the user to perform functionality provided by the platform 125 as described herein. Accordingly, the network 1304 can involve a variety of different networks such as, for example, a large computer network, such as a local area network (LAN), a wide area network (WAN), the Internet, a cellular network, a telephone network (e.g., PSTN) or an appropriate combination thereof.

In general, the server system 1305 can accept requests involving the various services provided through the enterprise software application 100 and provide services functionality to any number of user devices 1302 over the network 1304. Likewise, the server system 1305 can accept requests involving the platform 125 as described herein and provide platform functionality to any number of user devices 1302 over the network 1304. In various aspects, the server system 1305 can provide a cloud infrastructure to host a plurality of microservices 115 supporting the services of the enterprise software application 100 and/or platform 125. In some aspects, the server system 1305 can provision its computing resources based on modelling of network traffic associated with use of the plurality of microservices 115. Accordingly, the microservices 115 may be designed to communicate using communication methods and protocols, such as lightweight RESTful APIs (i.e., application programming interfaces (API) implemented using representational state transfer (REST) architectures). For example, the API may be implemented as a REST API, which may be accessed using the hypertext transfer protocol (HTTP), in a manner similar to a standard web page.

However, in certain aspects, any suitable communication protocol may be used.

### Example Computing Hardware

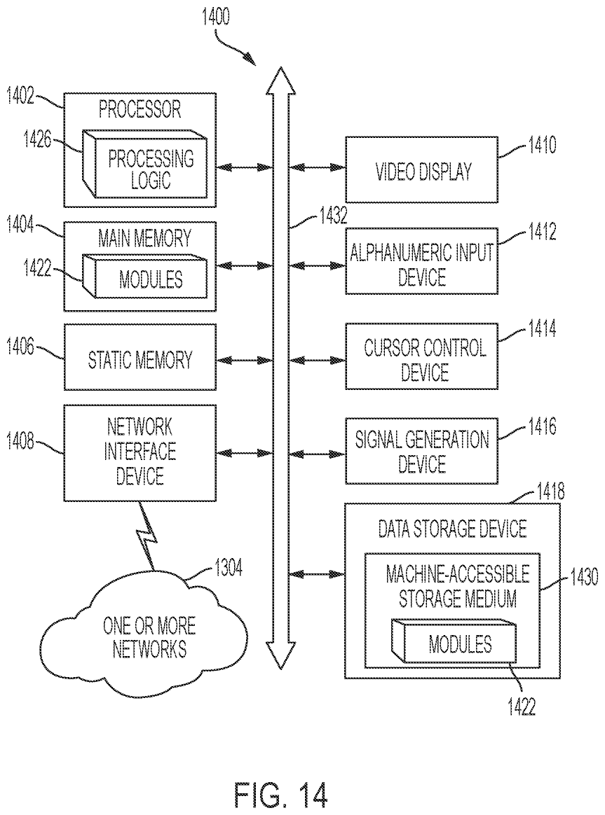

FIG. 14 illustrates a diagrammatic representation of an example of a computing hardware device 1400 that may be used in accordance with various aspects of the disclosure. For example, the hardware device 1400 may be computing hardware such as a server device 1306 and/or a user device 1302 as described in FIG. 13. In particular aspects, the hardware device 1400 may be connected (e.g., networked) to one or more other computing entities, storage devices, and/or the like via one or more networks such as, for example, a LAN, an intranet, an extranet, and/or the Internet. As noted above, the hardware device 1400 may operate in the capacity of a server and/or a client device in a client-server network environment, or as a peer computing device in a peer-to-peer (or distributed) network environment. Accordingly, in certain aspects, the hardware device 1400 may be a personal computer (PC), a tablet PC, a set-top box (STB), a Personal Digital Assistant (PDA), a mobile device (smart phone), a web appliance, a server, a network router, a switch or bridge, or any other device capable of executing a set of instructions (sequential or otherwise) that specify actions to be taken by that device. Further, while only a single hardware device 1400 is illustrated, the term “hardware device” shall also be taken to include any collection of hardware devices that individually or jointly execute a set (or multiple sets) of instructions to perform any one or more of the methodologies discussed herein.

The hardware device 1400 includes a processor 1402, a main memory 1404 (e.g., read-only memory (ROM), flash memory, dynamic random-access memory (DRAM) such as synchronous DRAM (SDRAM), Rambus DRAM (RDRAM), and/or the like), a static memory 1406 (e.g., flash memory, static random access memory (SRAM), and/or the like), and a data storage device 1418, that communicate with each other via a bus 1432.

The processor 1402 may represent one or more general-purpose processing devices such as a microprocessor, a central processing unit, and/or the like. In some aspects, the processor 1402 may be a complex instruction set computing (CISC) microprocessor, reduced instruction set computing (RISC) microprocessor, very long instruction word (VLIW) microprocessor, processor implementing other instruction sets, processors implementing a combination of instruction sets, and/or the like. In some aspects, the processor 1402 may be one or more special-purpose processing devices such as an application specific integrated circuit (ASIC), a field programmable gate array (FPGA), a digital signal processor (DSP), network processor, and/or the like. The processor 1402 may be configured to execute processing logic 1426 for performing various operations and/or steps described herein.

The hardware device 1400 may further include a network interface device 1408, as well as a video display unit 1410 (e.g., a liquid crystal display (LCD), a cathode ray tube (CRT), and/or the like), an alphanumeric input device 1412 (e.g., a keyboard), a cursor control device 1414 (e.g., a mouse, a track pad), and/or a signal generation device 1416 (e.g., a speaker). The hardware device 1400 may further include a data storage device 1418. The data storage device 1418 may include a non-transitory computer-readable storage medium 1430 (also known as a non-transitory computer-readable storage medium or a non-transitory computer-readable medium) on which is stored one or more modules 1422 (e.g., sets of software instructions) embodying any one or more of the methodologies or functions described herein. For example, the modules 1422 can include a data object type generation module 130, a relationship types identification module 140, a data object type identification module 150, a data object type instance generation module 160, a relationship types instance generation module 170, and a query module 180 as described herein. The one or more modules 1422 may also reside, completely or at least partially, within main memory 1404 and/or within the processor 1402 during execution thereof by the hardware device 1400, with the main memory 1404 and processor 1402 also constituting computer-accessible storage media. The one or more modules 1422 may further be transmitted or received over a network 1304 via the network interface device 1408.

While the computer-readable storage medium 1430 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 1400 and that causes the hardware device 1400 to perform any one or more of the methodologies of the present disclosure. The term “computer-readable storage medium” should accordingly be understood to include, but not be limited to, solid-state memories, optical and magnetic media, and/or the like.

### Exemplary System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### CONCLUSION

While this specification contains many specific aspect details, these should not be construed as limitations on the scope of any invention or of what may be claimed, but rather as descriptions of features that may be specific to particular aspects of particular inventions. Certain features that are described in this specification in the context of separate aspects may also be implemented in combination in a single aspect. Conversely, various features that are described in the context of a single aspect also may be implemented in multiple aspects separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in various aspects described above should not be understood as requiring such separation in all aspects, and it should be understood that the described program components (e.g., modules) and systems may generally be integrated together in a single software product or packaged into multiple software products.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for the purposes of limitation.

1. A method comprising:
providing a graphical user interface configured to allow for defining (i) a custom data object type used within a first data-related process of a plurality of data-related processes and (ii) a first plurality of attributes for the custom data object type, wherein the custom data object type is not found in a plurality of base data object types being used within the plurality of data-related processes;
receiving, by computing hardware, the custom data object type, the first plurality of attributes, and a relationship type that can exist between the custom data object type and a base data object type of the plurality of base data object types, wherein the base data object type is used within a second data-related process of the plurality of data-related processes;
generating, by the computing hardware, a first data object type node and an edge in a graph data representation, wherein the first data object type node represents the custom data object type and is associated with the first plurality of attributes and the edge represents the relationship type that can exist between the custom data object type and the base data object type and connects the first data object type node with a second data object type node representing the base data object type; and
generating, by the computing hardware, a visual representation for display on the graphical user interface, wherein the visual representation comprises at least a portion of the graph data representation showing the first data object type node, the second data object type node, and the edge.

2. The method of claim 1 further comprising:
receiving data, originating from the graphical user interface, wherein the data comprises:
a selection of the custom data object type,
a first property defined for a first attribute of the first plurality of attributes,
a selection of the base data object type,
a second property defined for a second attribute of a second plurality of attributes for the base data object type, and
a selection of the relationship type;
generating, by the computing hardware, a first instance node, a second instance node, and an instance edge in a second graph data representation, wherein the first instance node represents an instance of the custom data object type and is associated with the first property, the second instance node represents an instance of the base data object type and is associated with the second property, and the instance edge represents the relationship type existing between the instance of the custom data object type and the instance of the base data object type; and
generating, by the computing hardware, a second visual representation for display on the graphical user interface, wherein the second visual representation comprises at least a portion of the second graph data representation showing the first instance node, the second instance node, and the instance edge.

3. The method of claim 2 further comprising:
providing, by the computing hardware, a third visual representation for display on the graphical user interface, wherein the third visual representation comprises at least a portion of the graph data representation showing the first data object type node as selectable, the second data object type node as selectable, and the edge as selectable;
receiving, by the computing hardware, data originating from the graphical user interface, wherein the data comprises:
a selection of the first data object type node,
the first property defined for the first attribute,
a selection of the second data object type node,
a selection of the second attribute, and
a selection of the edge;
responsive to receiving the data, conducting, by the computing hardware, a traversal of the second graph data representation to retrieve the second property, wherein the traversal of the second graph data representation comprises:
identifying the first instance node in the second graph data representation based on the first property,
traversing the instance edge in the second graph data representation based on the edge to identify the second instance node, and
identifying the second property; and
providing, by the computing hardware, the second property for display in the graphical user interface.

4. The method of claim 1 further comprising populating, by the computing hardware, at least one placeholder field in a data schema for the first data-related process with data identifying the custom data object type and the first plurality of attributes.

5. The method of claim 1 further comprising:
providing a second graphical user interface configured to allow for defining (i) a custom relationship type and (ii) a third plurality of attributes for the custom relationship type;
receiving, by the computing hardware, the custom relationship type, the third plurality of attributes, and an indication that the custom relationship type can exist between the custom data object type and the base data object type;
generating, by the computing hardware, a second edge in the graph data representation, wherein the second edge represents the custom relationship type that can exist between the custom data object type and the base data object type, connects the first data object type node with the second data object type node, and is associated with the third plurality of attributes; and
providing, by the computing hardware, the second edge for display in the visual representation.

6. The method of claim 1, wherein each of the plurality of data-related processes comprises a microservice.

7. The method of claim 1, wherein the plurality of data-related processes supports an enterprise software application.

8. A method comprising:
providing, by computing hardware, a first data object type, a second data object type, and a relationship type in a graphical user interface for selection, wherein:
the first data object type (i) can be used within a plurality of data-related processes and (ii) is represented by a first data object type node (a) found in a first graph data representation of a graph data structure and (b) is associated with a first plurality of attributes defined for the first data object type,
the second data object type (i) can be used within the plurality of data-related processes and (ii) is represented by a second data object type node (a) found in the first graph data representation of the graph data structure and (b) is associated with a second plurality of attributes defined for the second data object type, and
the relationship type (i) can exist between the first data object type and the second data object type and (ii) is represented by an edge found in the first graph data representation of the graph data structure;
receiving data, originating from the graphical user interface, wherein the data comprises:
a selection of the first data object type to represent an instance of the first data object type used within a first data-related process of the plurality of data-related processes,
a first property for a first attribute of the first plurality of attributes,
a selection of the second data object type to represent an instance of the second data object type used within a second data-related process of the plurality of data-related processes,
a second property for a second attribute of the second plurality of attributes, and
a selection of the relationship type representing an instance of the relationship type existing between the instance of the first data object type and the instance of the second data object type;
generating, by the computing hardware, a first instance node, a second instance node, and an instance edge in a second graph data representation of the graph data structure, wherein the first instance node represents the instance of the first data object type and is associated with the first property, the second instance node represents the instance of the second data object type and is associated with the second property, and the instance edge represents the relationship type existing between the instance of the first data object type and the instance of the second data object type; and
generating, by the computing hardware, a visual representation for display on the graphical user interface, wherein the visual representation comprises at least a portion of the second graph data representation showing the first instance node, the second instance node, and the instance edge.

9. The method of claim 8 further comprising:
providing a second graphical user interface configured to allow for defining (i) the first data object type and (ii) the first plurality of attributes;
receiving, by the computing hardware, the first data object type, the first plurality of attributes; and
generating, by the computing hardware, the first data object type node and the edge in the first graph data representation.

10. The method of claim 8 further comprising:
providing, by the computing hardware, a second visual representation for display on the graphical user interface, wherein the second visual representation comprises at least a portion of the first graph data representation showing the first data object type node as selectable, the second data object type node as selectable, and the edge as selectable;
receiving, by the computing hardware, data originating from the graphical user interface, wherein the data comprises:
a selection of the first data object type node,
the first property defined for the first attribute,
a selection of the second data object type node,
the second attribute, and
a selection of the edge;
responsive to receiving the data, conducting, by the computing hardware, a traversal of the second graph data representation to retrieve the second property, wherein the traversal of the second graph data representation comprises:
identifying the first instance node in the second graph data representation based on the first property,
traversing the instance edge in the second graph data representation based on the edge to identify the second instance node, and
identifying the second property; and
providing, by the computing hardware, the second property for display on the graphical user interface.

11. The method of claim 8 further comprising populating, by the computing hardware, at least one placeholder field in a data schema for the first data-related process with data identifying the first data object type and the first plurality of attributes.

12. The method of claim 8 comprising:
providing a second graphical user interface configured to allow for defining (i) a custom relationship type and (ii) a third plurality of attributes for the custom relationship type;
receiving, by the computing hardware, the custom relationship type, the third plurality of attributes, and an indication that the custom relationship type can exist between the first data object type and the second data object type;
generating, by the computing hardware, a second edge in the first graph data representation, wherein the second edge represents the custom relationship type that can exist between the first data object type and the second data object type, connects the first data object type node with the second data object type node, and is associated with the third plurality of attributes; and
providing, by the computing hardware, the second edge for display in the visual representation.

13. The method of claim 8, wherein each of the plurality of data-related processes comprises a microservice.

14. The method of claim 8, wherein the plurality of data-related processes supports an enterprise software application.

15-20. (canceled)

21. A method comprising:
providing, by computing hardware, a graphical user interface for display on a computing device, wherein the graphical user interface displays a visual representation of at least a portion of a schema graph representation as:
a plurality of data object type nodes representing a plurality of data object types that can be used within a plurality of data-related processes in which each data object type node of the plurality of data object type nodes (i) is selectable and (ii) is associated with a plurality of corresponding attributes,
a plurality of relationship type edges representing relationship types that can exist between the plurality of data object types in which each relationship type edge of the plurality of relationship type edges (i) is selectable and (ii) connects two data object type nodes of the plurality of data object type nodes,
receiving, by the computing hardware, data originating from the graphical user interface, wherein the data comprises:
a selection of a first data object type node from the plurality of data object type nodes,
a first property defined for a first attribute of the plurality of corresponding attributes associated with the first data object type node,
a selection of a second data object type node from the plurality of data object type nodes,
a selection of a relationship type edge of the plurality of relationship type edges displayed on the graphical user interface connecting the first data object type node and the second data object type node, and
a selection of a second attribute of the plurality of corresponding attributes associated with the second data object type node;
responsive to receiving the data, conducting, by the computing hardware, a traversal of an operations graph representation to retrieve a second property for the second attribute, wherein the traversal of the operations graph representation comprises:
identifying a first data object instance node in the operations graph representation based on the first property, the first data object instance node representing a first instance of a use of a first data object type represented by the first data object type node in a first data-related process of the plurality of data-related processes,
traversing an instance edge in the operations graph representation based on the relationship type edge connecting the first data object type node and the second data object type node to identify a second data object instance node, the second data object instance node representing a second instance of a use of a second data object type represented by the second data object type node in a second data-related process of the plurality of data-related processes, and
identifying the second property associated with the second data object instance node; and
providing, by the computing hardware, the second property for display on the graphical user interface.

22. The method of claim 21, wherein the portion of the schema graph representation is based on a particular workflow.

23. The method of claim 22, wherein the graphical user interface further displays a plurality of workflows, and the method further comprises receiving a selection of the particular workflow.

24. The method of claim 22, wherein at least one of the plurality of data object types or the plurality of relationship type edges is based on the particular workflow.

25. The method of claim 21 further comprising:
querying, by the computing hardware, a repository of the second data-related process to retrieve an additional property associated with the second instance of the use of the second data object type represented by the second data object type node; and
providing, by the computing hardware, the second property for display on the graphical user interface.
